(19) United States
(12) Patent Application Publication
(10) Pub. No.: US 2009/0159815 A1
(43) Pub. Date: Jun. 25, 2009

(54) FLUORESCENCE OBSERVATION OR FLUORESCENCE MEASURING SYSTEM AND METHOD

(75) Inventors: Hiroaki Kinoshita, Akishima-shi (JP); Atsushi Niwa, Kyoto-shi (JP); Masahiro Satoh, Kyoto-shi (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/336,824

(22) Filed: Dec. 17, 2008

(30) Foreign Application Priority Data
Dec. 19, 2007 (JP) 2007-327788

(51) Int. Cl. G01J 1/58

(52) U.S. Cl. 250/459.1; 250/458.1

(57) ABSTRACT

The fluorescence observation or fluorescence photometry system uses an optical base material having low autofluorescence and good adhesive property to cell. Said optical base material has the following optical characteristics:

1.3≦nd≦1.9

15≦νd≦100
where nd represents refractive index in d line, and νd represents Abbe number in d line; and, an optical instrument constituted for enabling a fluorescence observation and/or a fluorescence measurement is arranged. Thereby, a fluorescence observation or a fluorescence photometry system, and a fluorescence observation or a fluorescence photometry method in which sufficient signal obtained from a cell can be obtained as much as possible, and more accurate observation and measurement can be promoted is offered.

This application claims benefits of Japanese Patent Application No. 2007-327788 filed in Japan on Dec. 19, 2007, the contents in which are hereby incorporated by reference.

### BACKGROUND OF THE INVENTION

1. Field of the Invention

The present invention relates to a fluorescence observation or fluorescence photometry system, and a fluorescence observation or a fluorescence photometry method using an optical base material having low autofluorescence and good adhesive property to cell. In more details, it relates to a fluorescence observation or fluorescence photometry system, and a fluorescence observation or a fluorescence photometry method using an optical base material having low autofluorescence and good adhesive property to cell, in which for example, a cover glass (sheet), a dish, a well plate, a cell, and the like are used by arranging these so as to touch a sample between an objective lens and the sample.

2. Description of the Related Art

In recent years, measurement devices and apparatuses in a microscope field, a fluorescence microscope field, a field concerning a protein and DNA analysis, etc., have been developing. Under such circumstances, trend of the observation and/or measurement in these fields is changing. There are the following two big flows as change of the trend.

One of them is a change of observation and/or measurement object. That is to say, there is a trend toward observation and/or measurement of a living cell from observation and/or measurement of a fixed cell. In the present age of post-genome, the importance of technology where weak fluorescence can be observed and/or measured correctly by using a wide wavelength band for fluorescent light measurement of single molecule of fluorescence pigments, a simultaneous analysis of a living body function by multiple-colorizing of a fluorescence pigment etc., is increasing. Particularly, in recent years, in the most advanced research field, for the purpose of elucidation of function of a living body, analysis of behavior of protein, and/or analysis of interaction of these, etc., needs of observing a living cell over a long time (from several days to several weeks) are growing, and various techniques for such observation has been developed.

As observation techniques of such cell, techniques of observing its fluorescence have been used well by generating a fluorescence protein in a designated cell, or by introducing a fluorescence pigment. As the latest technology, there is single molecule fluorescence observation that can be considered as the supreme method as weak fluorescence observation, and a trend toward observation and/or measurement of much more weak fluorescence can be seen. Also in a general fluorescence observation, if the light (excitation light) for exciting a fluorescent substance is too strong, a cell will be damaged. Accordingly, in order to keeping a cell alive for a long time, it is necessary to weaken intensity of the excitation light as much as possible. Not only in observation of a cell, it has been known that the fluorescence will fade away when a fluorescent substance is irradiated by the excitation light. Also, in order to suppress fading of the fluorescence by irradiating weak excitation light, it is very useful to enable to carry out observation with a sufficient S/N ratio by weak fluorescence.

However, if weak excitation light is used, the fluorescence intensity detected also becomes weak. Accordingly, it becomes difficult to obtain an image with high S/N ratio. In the single molecule fluorescence observation that is the supreme weak fluorescence observation, among others, as the weaker fluorescence is, the larger influence of noise becomes, and S/N ratio will be lowered. Here, a noise means autofluorescence generated from an optical system, a sample, etc.

Another one is a change such that from an apparatus equipped with function for observation only such as a conventional microscope apparatus to an apparatus equipped with a means for measuring fluorescence intensity, a wavelength, and existence of an examination object to be detected etc. The exact measurement performance including for a noise has been needed.

In fluorescence observation apparatuses such as fluorescence microscope, etc., and in fluorescence measurement apparatus such as genome/protein analysis apparatus, etc., various wavelengths are observed and/or measured widely over the infrared range from the ultraviolet range. The fluorescence observation and/or measurement by three excitation especially called U excitation, B excitation, and G excitation are typical. Particularly, fluorescence observation and/or measurement by three excitations called such as U excitation, B excitation, and G excitation is typical. In U excitation, the excitation is made with wavelength of near 356 nm, and then fluorescence near 450 nm is observed and/or measured. In B excitation, the excitation is made with wavelength of near 488 nm, and then fluorescence near 540 nm is observed and/or measured. In G excitation, the excitation is made with wavelength of near 550 nm, and then fluorescence near 600 nm is observed and/or measured.

As a conventional fluorescence observation apparatus and fluorescence measurement apparatus, for example, it has been proposed in Japanese published unexamined patent application Toku Kai Hei 08-320437, and Japanese published unexamined patent application Toku Kai Hei 08-178849.

As conventional microscope for fluorescence observation, for example, in an apparatus shown in Publication of the Japanese published unexamined patent application, Toku Kai No. 2001-83318, a microscope constituted so that the fluorescence observation by usual epi-illumination and the fluorescence observation by a total reflection lighting may be selected by switching them has been shown. In the fluorescence detection system through a conventional fluorescence microscope such as the microscope shown in Japanese published unexamined patent application, Toku Kai No. 2001-83318, etc., it is constituted so that a fluorescent substance may be irradiated, and a sample may be observed by detecting fluorescence emitted from the fluorescent substance.

In the fluorescence microscope observation and/or measurement of a living cell, a cell is made to adhere to a substrate, and is observed and/or measured. As an optical base material arranged between an objective lens and the sample where it is contacted with the sample, cover glass, plastic dish, and the like have been used.

However, generally a cell cannot be easily implanted on a glass. For this reason, it is difficult to maintain the activity of the cell on a glass substrate. Accordingly, in fluorescence observation of the living cell using glass optical base materials such as a cover glass, an amount of fluorescence obtained as a signal from observation and/or measurement is small at the beginning, or it decreases remarkably soon. Therefore, there was a problem that observation is difficult, or measurement in process of time is difficult.

Optical base materials on which surface finishing is conducted for raising an adhesive property of the cell to a base material have been shown, for example, in Japanese published unexamined patent application Toku Kai No. 2007-20444, Toku Kai No. 2005-227944, Toku Kai. No. 2006-189355,Toku Kai. No. 2006-189355, and Toku Kai. No. 2006-258805. These shown in such prior art literatures are coated with a compound containing amino group having good affinity for cell on the surface of a glass base material.

### SUMMARY OF THE INVENTION

According to the present invention, a fluorescence observation or fluorescence photometry system using an optical base material having low autofluorescence and good adhesive property to cell is characterized in that the optical base material having low autofluorescence and good adhesive property to cell has the following optical characteristics:

1.3≦nd≦1.9

15≦νd≦100

where nd represents refractive index in d line, and νd represents Abbe number in d line; and an optical instrument constituted for enabling a fluorescence observation and/or a fluorescence measurement is arranged.

According to the present invention, a fluorescence observation or fluorescence photometry system using an optical base material having low autofluorescence and good adhesive property to cell is characterized in that the optical base material having low autofluorescence and good adhesive property to cell has the following optical characteristics:

1.6≦nd≦1.9

35≦νd≦65

where nd represents refractive index in d line, and νd represents Abbe number in d line; and an optical instrument constituted for enabling a fluorescence observation and/or a fluorescence measurement is arranged.

According to the present invention, a fluorescence observation or fluorescence photometry system using an optical base material having low autofluorescence and good adhesive property to cell is characterized in that the optical base material having low autofluorescence and good adhesive property to cell has the following optical characteristics:

1.7≦nd≦1.8

40≦νd 60

where nd represents refractive index in d line, and νd represents Abbe number in d line; and an optical instrument constituted for enabling a fluorescence observation and/or a fluorescence measurement is arranged.

According to the present invention, a fluorescence observation or fluorescence photometry system using an optical base material having low autofluorescence and good adhesive property to cell is characterized in that the optical base material having low autofluorescence and good adhesive property to cell has the following optical characteristics:

1.35≦nd≦1.5

30≦νd≦100

where nd represents refractive index in d line, and νd represents Abbe number in d line; and an optical instrument constituted for enabling a fluorescence observation and/or a fluorescence measurement is arranged.

According to the present invention, a fluorescence observation or fluorescence photometry system using an optical base material having low autofluorescence and good adhesive property to cell is characterized in that the optical base material having low autofluorescence and good adhesive property to cell has the following optical characteristics:

1.37≦nd≦1.48

35≦νd≦75

where nd represents refractive index in d line, and νd represents Abbe number in d line; and an optical instrument constituted for enabling a fluorescence observation and/or a fluorescence measurement is arranged.

In the fluorescence observation or fluorescence photometry system using an optical base material having low autofluorescence and good adhesive property to cell according to the present invention it is desired that a surface of said optical base material having low autofluorescence and good adhesive property to cell is coated with silane coupling reagent containing amino group, having positive charge.

Furthermore, in the fluorescence observation or fluorescence photometry system using an optical base material having low autofluorescence and good adhesive property to cell according to the present invention, it is desired that as for said optical base material having low autofluorescence and good adhesive property to cell, glass base material is coated with said silane coupling reagent.

In the fluorescence observation or fluorescence photometry system using an optical base material having low autofluorescence and good adhesive property to cell according to the present invention, it is desired that said optical base material having low autofluorescence and good adhesive property to cell satisfies the following condition (1-1):

B_{CG′}/B_{CG}≦0.7 (1-1)

where B_{CG′} is an average of the intensity of the autofluorescence of said optical base material having low autofluorescence and good adhesive property to cell, and B_{CG} is an average of the intensity of the autofluorescence of a cover glass generally used conventionally.

Furthermore, the fluorescence observation or fluorescence photometry method using an optical base material having low autofluorescence and good adhesive property to cell according to the present invention is characterized in that in a fluorescence observation or a fluorescence photometry method, it comprises the following processes (A), (B) and (C):
(A) a process for selecting a sample which emits fluorescence using a living cell;
(B) a process for selecting an application for observing or measuring the light of the sample selected by said process (A), and a fluorescence observation or fluorescence photometry system using an optical base material having low autofluorescence and good adhesive property to cell according to any one of said inventions, wherein the following condition (1-1) is satisfied; and
(C) a process for carrying out fluorescence observation or fluorescence measurement of the light of the sample selected by said process (A) by using the application and the system selected by said process (B):

B_{CG′}/B_{CG}≦0.7 (1-1)

where B_{CG′} is an average of the intensity of the autofluorescence of the optical base material having low autofluorescence and good adhesive property to cell, and B_{CG} is an average of the intensity of the autofluorescence of a cover glass generally used conventionally.

In the fluorescence observation or fluorescence photometry system using an optical base material having low autofluorescence and good adhesive property to cell according to the present invention, it is desired that the sample which emits fluorescence by using a living cell selected by said process (A) satisfies at least one of the following conditions (2-1) and (3-1):

(S−s)/(B+b)≦5 (2-1)

3B_{CG}/B≧0.2 (3-1)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

In the fluorescence observation or fluorescence photometry method using an optical base material having low autofluorescence and good adhesive property to cell according to the present invention, it is desired that an application selected by said process (B) is FRET (Fluorescence Resonance Energy Transfer).

In the fluorescence observation or fluorescence photometry method using an optical base material having low autofluorescence and good adhesive property to cell according to the present invention, it is desired that the application selected by said process (B) is an animation observation or a time lapse observation.

In the fluorescence observation or fluorescence photometry method using an optical base material having low autofluorescence and good adhesive property to cell according to the present invention, it is desired that the system selected by said process (B) is a fluorescence microscope system.

In the fluorescence observation or fluorescence photometry method using an optical base material having low autofluorescence and good adhesive property to cell according to the present invention, it is desired that the system selected by said process (B) is a total reflection microscope system.

In the fluorescence observation or fluorescence photometry method using an optical base material having low autofluorescence and good adhesive property to cell according to the present invention, it is desired that the system selected by said process (B) has two fluorescence microscopes or two total reflection microscopes; otherwise, one fluorescence microscope and one total reflection microscope; and the system is constituted as a microscope system in which said sample is sandwiched between the objective optical systems being faced each other.

According to the present invention, a fluorescence observation or fluorescence photometry system using an optical base material having low autofluorescence and good adhesive property to cell, and a fluorescence observation or a fluorescence photometry method by which influence of the noise by autofluorescence is reduced efficiently, and a highly precise and good quality fluorescence observation, fluorescence measurement, and furthermore observation and measurement of weak fluorescence can be made, and further, many signals can be obtained from the cell as much as possible, and accuracy of observation and/or measurement can be raised when fluorescence observation and/or measurement over the long period of time of a living cell is carried out by using a microscope designed responding to the observation and/or measurement in the low refractive index or a high refractive index can be obtained.

These and other features advantages of the present invention will become apparent from the following detailed description of the preferred embodiments when taken in conjunction with the accompanying drawings.

### BRIEF DESCRIPTION OF THE DRAWINGS

FIG. 1 is a side view showing one example of a constitution of a conventional inverted fluorescence microscope apparatus for which the fluorescence observation or fluorescence photometry system of embodiment of the present invention can be applied, and an outline diagram of an incident light fluorescence microscope apparatus using a laser light source.

FIG. 2 is a side view showing one example of a constitution of a conventional inverted fluorescence microscope apparatus for which the fluorescence observation or fluorescence photometry system of embodiment of the present invention can be applied, and an outline diagram of an incident light fluorescence microscope apparatus using white arc light source.

FIGS. 3A and 3B are explanatory diagrams showing a principal part of the illumination light optical system in the fluorescence microscope apparatus of FIG. 1, showing arrangement of the optical element at the time of the usual epi-illumination, and arrangement of the optical element at the time of a total reflection illumination, respectively.

FIG. 4, is a diagrammatic chart showing the number of adhered cell in a designated cell culture time with respect to an optical base material having low autofluorescence and good adhesive property to cell used for the fluorescence observation and/or a fluorescence photometry system in embodiments 1 and 2, and an optical base material used for the fluorescence observation and/or fluorescence photometry system in a comparative example 2, respectively.

### DETAILED DESCRIPTION OF THE PREFERRED EMBODIMENTS

In the present invention, “an optical base material having low autofluorescence and good adhesive property to cell” represents “an optical element that is an optical element for holding a fluorescence observation specimen on a microscope stage; and that affects image forming performance, and has a low autofluorescence and good cell adhesion property, wherein a fluorescence observation image is affected by the autofluorescence generated in itself”. In “an optical element for holding a fluorescence observation specimen on a microscope stage; and giving affects an image forming performance, and a fluorescence observation image by the autofluorescence generated in itself” includes concretely, for example, a cover glass, a glass bottom dish, etc., but does not include an optical element, such as slide glass that does not affect an image forming performance.

Prior to explanation of embodiments of the present invention, background and the course that the present invention has been made will be explained.

(Ranking of S/N Ratio of Images of Fluorescence with Respect to the Brightness of a Sample)

Firstly, the inventor of the present invention attempted to carry out ranking of every sample used for observation and/or photometry as mentioned later, with respect to noise level required for a highly precise and qualified fluorescence observation and fluorescence photometry, and furthermore, a fluorescence observation apparatus and fluorescence-photometry apparatus in which application (inspection mirror method) of weak fluorescence observation, weak fluorescence photometry etc., can be used.

Here, a formula used for the ranking is defined as follows

The S/N ratio of application is defined by the following condition (2-0):

(S−s)/(B+b) (2-0)

where S is an average of the fluorescence intensity of an observation object (or object to be measured by light); B is average of the intensity of the autofluorescence of a background (portion in which an observation object or an object to be measured by light does not exist in an observation area); and s and b are fluctuation of those intensity, respectively.

### (1) Single Molecule Fluorescence Observation

First, as a sample which is most easily influenced by the autofluorescence, so-called S/N ratio of single molecule fluorescence observation was considered. In single molecule fluorescence observation, the autofluorescence of an observation optical system or a photometry optical system is a main noise component. In single molecule fluorescence observation S/N ratio satisfies the following condition (2-3):

(S−s)/(B+b)≦2 (2-3)

### (2) Fluorescence Observation of a Relatively Dark Sample

Next, fluorescence observation (or photometry) using a living cell was considered.

In living cell observation apparatus, it is necessary to maintain activity of a cell over a long time. Generally, in order to reduce an damage to the cell, lessening an amount of a fluorescent substance and weakening the irradiation intensity of excitation light to the living cell are used. Therefore, there is a tendency that the intensity of fluorescence becomes small easily. A S/N ratio satisfies the following condition (2-2) in the fluorescence observation of a dark sample:

(S−s)/(B+b)≦3 (2-2)

### (3) Fluorescence Observation of the Sample of Normal Brightness

Finally, in the fluorescence observation using a general fixed cell (or photometry), or in the fluorescence observation using a living cell, a case where fluorescence intensity was strong was considered. In case of a fixed cell since it is not necessary to maintain the activity of the cell, concentration of a fluorescent substance can be made high, or an excitation light intensity can be strengthened. Accordingly, fluorescence intensity can be raised. When a living cell is used, a case that a period for maintaining activity is short, and a case that a fluorescent protein is generated in a portion where influence on a cell is small, and the like are corresponded to the case mentioned above. In this case, a S/N ratio satisfies the following condition (2-1):

(S−s)/(B+b)≦5 (2-1)

As mentioned above, the inventor of the present invention classified the brightness of the sample used for the fluorescence observation (or photometry) into three kinds according to the S/N ratio of the application.

(Kinds of Application)

Next, the inventor of the present invention considered the kinds of application for carrying out the fluorescence observation (or photometry) of these samples.

### (1) FRET Observation

As one of techniques frequently used for observing or measuring the strength of the light of a fluorescence sample, there is FRET (Fluorescence Resonance Energy Transfer). In FRET, two fluorescent substances, that are a donor substance and an acceptor substance, are used, and the fluorescence wavelength of the donor substance and the excitation wavelength of the acceptor substance are made to be coincided nearly. Therefore, the wavelength of the excitation light in FRET is nearer the short wavelength side than the wavelength of the excitation light in case of using an acceptor substance independently. On the other hand, the autofluorescence of observation or photometry optical system has a tendency that it becomes stronger, the shorter the wavelength of excitation light becomes. Accordingly, in FRET, even in a case that the same fluorescence wavelength is observed or measured, there is a problem that the autofluorescence from observation or photometry optical system becomes large.

### (2) Calcium Ion Imaging

As a substance playing a big role in transfer of a signal between cells, or in a cell, there is calcium ion. Observing, or measuring light in a concentration gradient, or change of concentration of the calcium ion is very important in the functional elucidation of a cell. As a reagent frequently used in detecting concentration of calcium ion, there are Fura-2 and Indo-1. To these reagents as excitation light, UV light with wavelength of 300˜400 nm is used. Therefore, there was a problem that autofluorescence from observation or photometry optical system became large. In recent years, a fluorescence reagent called Cameleon for which UV light is not used has been offered. However, since Cameleon is a reagent for which FRET mentioned above is applied, the same problem as a case of FRET arises.

### (3) Sequential Observation; Time Lapse Observation

In case that single molecule on a cell membrane is observed, and FRET and calcium ion imaging, it is important to investigate not only the ratio of the intensity but the time change of the ratio of the intensity. When a speed of the change is quick, animation observation by video rate or higher speed than it is carried out. In case of the animation observation, in order to detect a phenomenon of quick change, exposure time per one frame of the camera becomes short inevitably Accordingly, the level of brightness becomes low. Thus, in case of the animation observation, since the fluorescence is weak compared with that in general fluorescence observation or photometry, it is difficult to obtain image data with good S/N ratio.

On the other hand, when change is slow, time lapse observation in which the observation continues intermittently over long time from several hours to several days is carried out. In the time lapse observation, since it is necessary to maintain activity of the cell over the long time, it is required that intensity of the excitation light irradiated to the sample cell should be made as small as possible. Accordingly, in the time lapse observation, it is difficult to obtain image data with good S/N ratio since the fluorescence is weak compared with that in general fluorescence observation or photometry.

As stated above, also in various applications for observing the fluorescence sample, a degradation factor of S/N ratio according to the application exists. Actually, by combining with a sample satisfying at least one of conditions (2-1)˜(2-3) concerning brightness, and each application in conditions (1)˜(3) mentioned above, fluorescence observation or photometry has been carried out, and the S/N ratio is also determined according to combination of conditions (2-1)˜(2-3) and applications (1)-(3).

(Investigation of Autofluorescence Rate)

Next, the inventor of the present invention investigated each autofluorescence rate of optical systems, such as microscope and light measurement apparatus using conventional, common objective lens, immersion substance, cover glass, and the like. Noise in the fluorescence microscope system can be divided roughly into autofluorescence from the sample, and autofluorescence from the optical system.

The inventor of the present invention investigated rate of the autofluorescence from the sample and the autofluorescence from the optical system as to noise components in case that that measurement is carried out using an erected-image-microscope BX51 (product made by OLYMPUS Co.).

As for the light emitted from the light source, light having a wavelength suitable to the observation purpose is selected by a filter (for example, filter unit of U-MWIB3 (made by OLYMPUS Co.)), passes through an illumination light optical system, and then is irradiated to a sample as excitation light. In that case, an objective lens, an immersion substance, and a cover glass which have been arranged in the illumination light optical system, and an substance enclosed together with the sample are excited, and autofluorescence generating noises is emitted. The inventor of the present invention measured quantity of the autofluorescence mentioned above using a detector attached to observation optical system, such as photo multipliers (made by Hamamatsu Photonics Co.), Cool SNAP HQ (made by Photometrics Co.) which is cooling type CCD, and the like.

Firstly, the autofluorescence from the background of the sample is measured by the normal vertical fluorescence observation method, and then the measurement of the autofluorescence is carried out in a state excluding the sample. The difference of these values is the value of the autofluorescence from the sample, and the remainder is computed as the autofluorescence from the optical system. It became clear that the autofluorescence from the sample out of the computed noise changed sharply by a cleaning method of the sample mentioned later, and a condition of production of the sample, for example. At the result, the inventor of the present invention found out that tendency of a degree of influence exerted on the whole noise by the noise of the autofluorescence from the sample could roughly be classified into three according to production conditions of the sample. As for the rate of the noise of the autofluorescence from the optical system to the whole noise, it can be expressed as follows.

Ordinary Sample (Not Washed):

(noise of the autofluorescence from the optical system)/B≧0.2 (3′-1)

Washed Sample:

(noise of the autofluorescence from the optical system)/B≧0.4 (3′-2)

Sample Washed Very Cleanly:

(noise of the autofluorescence from the optical system)/B≧0.6 (3′-3)

Here, in conditions mentioned above (3′-1)˜(3′-3), B is an average value of the intensity of autofluorescence of background (a area in which an observation object, or an examined object does not exist in the observation area)

In conditions mentioned above (3′-1)˜(3′-3), if the larger the lower limit becomes, the larger a rate that the noise of the autofluorescence from the optical system occupies becomes, and the autofluorescence from the optical system is improved, its effect is obtained notably.

It is necessary to know details of the noise of the autofluorescence from the optical system for improving the S/N ratio. Thus, the inventor of the present invention investigated the rate of each of values of noise (autofluorescence) of the objective, the immersion substance, and the cover glass. As for the measuring method, the same method as used in the case of investigating the rate of the autofluorescence from the sample and the autofluorescence from the optical system, as mentioned above was used.

First, an amount of autofluorescence detected in a state (actually used condition) where the objective lens, the immersion substance, and the cover glass are properly arranged to the illumination light optical system was measured. Then, measurement was carried out after removing the cover glass from the optical system, and next, the autofluorescence in a state excluding the immersion oil from the optical system was measured, and then autofluorescence values were computed from each of the objective lens, the immersion oil, and the cover glass by counting difference between each value of these.

Measurements were carried out about values of the autofluorescence from each of UPLSAPO60XO (product made by OLYMPUS Co.), immersion oil (product made by OLYMPUS Co.), and cover glass (product made by Matsunami Glass Cutter Business Co.) In this case, the values of autofluorescence of the objective, the immersion oil, and the cover glass were early the same.

Further, autofluorescence in a state excluding the objective lens from the optical system was measured, and a difference between its value and the measured value of the autofluorescence in the state where the objective lens was arranged at the optical system was counted, and then autofluorescence values of the other optical elements were calculated. In this case, the autofluorescence values were around 10 percents of the amount of autofluorescence detected in a state (actually used condition) where the objective lens, the immersion substance, and the cover glass are properly arranged to the illumination light optical system.

As a result, it proved that as for the autofluorescence occupied in the noise of the whole observation optical system (or photometry optical system) of the optical system, it was around 30 percent in case of the objective lens; as to the immersion substance, it was around 30 percent; as to the cover glass, it was around 30 percent; and as to the others, it was around 10 percent. Then, it became clear that for weak fluorescence observation (or measurement) the autofluorescence from the objective lens, the immersion substance, and the cover glass as mentioned above causes deterioration of quality, and it is in level which cannot be disregarded in maintaining performance of the whole system.

The inventor of the present invention has found, after careful investigation, that in order to improve the S/N ratio by 5%, it is required that out of three kinds of autofluorescence from the objective lens, the immersion substance, and the cover glass, at least one of autofluorescence is reduced by 30%, otherwise the whole of these three kinds of autofluorescence is reduced by 10%.

Then, the inventor of the present invention has invented the present invention by getting an idea and conception that if “an optical element which holds the fluorescence observation specimen on the microscope stage, and affects an image forming performance, wherein autofluorescence generated in itself affects an image of the fluorescence observation” such as the cover glass and the like, is constituted such that it may have a property of low autofluorescence and good cell adhesion, signals of the cell increase, and accordingly it is possible to maintain accuracy of observation and/or measurement even if the autofluorescence from the lens and the oil increases somewhat.

That is to say, in the fluorescence observation or the fluorescence photometry system using the optical base material having low autofluorescence and good adhesive property to cell according to the present invention, said optical element having low autofluorescence and good adhesive property to cell satisfies the following condition (1-1):

B_{CG′}/B_{CG}≦0.7 (1-1)

where B_{CG′} is an average of the intensity of the autofluorescence of said optical base material having low autofluorescence and good adhesive property to cell, and B_{CG} is an average of the intensity of the autofluorescence of a cover glass generally used conventionally.

Upper limit of the condition (1-1) mentioned above is reduced from the effect that “in order to improve the S/N ratio 5%, it is necessary to reduce at least one of the autofluorescence by 30% out of three kinds of autofluorescence, namely the objective, the immersion substance, and the cover glass.” as mentioned above.

In the fluorescence observation or the fluorescence photometry system using the optical base material having low autofluorescence and good adhesive property to cell of the present invention, it is more desirable to satisfy the following condition (1-2):

B_{CG′}/B_{CG}≦0.5 (1-2)

where B_{CG′} is an average of the intensity of the autofluorescence of said optical base material, and B_{CG} is an average of the intensity of the autofluorescence of a cover glass generally used conventionally.

Further, in the fluorescence observation or the fluorescence photometry system using the optical base material having low autofluorescence and good adhesive property to cell of the present invention, it is more desirable to satisfy the following condition (1-3):

B_{CG′}/B_{CG}≦0.3 (1-3)

where B_{CG′} is an average of the intensity of the autofluorescence of said optical base material, and B_{CG} is an average of the intensity of the autofluorescence of a cover glass generally used conventionally.

The fluorescence observation or the fluorescence photometry method using the optical base material having low autofluorescence and good adhesive property to cell of the present invention, in fluorescence observation or the fluorescence photometry method, consists of the following processes (A), (B), and (C):
(A) a process for selecting the sample which emits the fluorescence using a living cell;
(B) a process for selecting an application for observing or measuring the intensity of the light of the sample selected by said process (A), and a fluorescence observation or fluorescence photometry system using an optical base material having low autofluorescence and good adhesive property to cell according to Claims 1˜7, wherein the following condition (1-1) is satisfied;
(C) a process for carrying out the fluorescence observation or the fluorescence photometry of the sample selected by said process (A), by using the application and the system which were selected by said process:

B_{CG′}/B_{CG}≦0.7 (1-1)

where B_{CG′} is an average of the intensity of the autofluorescence of said optical base material having low autofluorescence and good adhesive property to cell, and B_{CG} is an average of the intensity of the autofluorescence of a cover glass generally used conventionally.

Upper limit of the condition (1-1) mentioned above is drawn from the effect that “in order to improve the S/N ratio 5%, it is necessary to reduce at least one of the autofluorescence by 30% out of three kinds of autofluorescence namely, the objective the immersion substance, and the cover glass” as mentioned above.

In the fluorescence observation or the fluorescence photometry method using the optical base material having low autofluorescence and good adhesive property to cell of the present invention, it is more desired that said optical element having low autofluorescence and good adhesive property to cell, which is used in said process (B) satisfies the following condition (1-2):

B_{CG′}/B_{CG}≦0.5 (1-2)

where B_{CG′} is an average of the intensity of the autofluorescence of said optical base material having low autofluorescence and good adhesive property to cell, and B_{CG} is an average of the intensity of the autofluorescence of a cover glass generally used conventionally.

Further, in the fluorescence observation or the fluorescence photometry method using the optical base material having low autofluorescence and good adhesive property to cell of the present invention, it is much more desired that said optical element having low autofluorescence and good adhesive property to cell, which is used in said process (B) satisfies the following condition (1-3):

B_{CG′}/B_{CG}≦0.3 (1-3)

where B_{CG′} is an average of the intensity of the autofluorescence of said optical base material, and B_{CG} is an average of the intensity of the autofluorescence of a cover glass generally used conventionally.

In the fluorescence observation or the fluorescence photometry method using the optical base material having low autofluorescence and good adhesive property to cell of the present invention, it is desired that the sample which emits the fluorescence using a living cell, and is selected by said process (A) satisfies at least one of the following conditions (2-1) and (3-1):

(S−s)/(B+b)≦5 (2-1)

3B_{CG}/B≧0.2 (3-1)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

Upper limit of the condition (2-1) mentioned above is made to correspond to the S/N ratio of application which is required when carrying out the fluorescence observation and/or fluorescence photometry for “the sample of the usual brightness” in the ranking of the brightness of the sample as mentioned above. Lower limit of the condition (3-1) mentioned above is made to correspond to the condition (3′-1) about “the ordinary sample (not washed)” in the rate of the noise of the autofluorescence from the optical system to the whole noises, as mentioned above. The left side of the condition (3-1) is induced from the effect that “as for the proportion of autofluorescence in the noise of the whole observation optical system (or photometry optical system) of the optical system, it was around 30 percent in case of the objective lens; it was around 30 percent about the immersion substance; it was about 30 percent in case of the cover glass.” and as for the objective lens, the immersion substance, and the cover glass, each proportion of the noise in the optical system is the same as mentioned before; and by replacing the rate of the noise of the objective lens and the autofluorescence of the immersion substance out of noises in the autofluorescence from the optical system to the rate of the noise of the autofluorescence of the cover glass by using the condition (3′-1)

In the fluorescence observation or the fluorescence photometry method using the optical base material having low autofluorescence and good adhesive property to cell of the present invention, it is desired that the sample which emits the fluorescence using a living cell, and is selected by said process (A) satisfies at least one of the following conditions (2-2) and (3-2):

(S−s)/(B+b)≦3 (2-2)

3B_{CG}/B≧0.4 (3-2)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

Upper limit of the condition (3-2) mentioned above is made to correspond to the S/N ratio of application which is required when carrying out the fluorescence observation and/or fluorescence photometry for “the dark sample” in the ranking of the brightness of the sample as mentioned above. Lower limit of the condition (3-2) mentioned above is made to correspond to the condition (3-2′) about “the washed sample” in the rate of the noise of the autofluorescence from the optical system to the whole noises, as mentioned above. The left side of the condition (3-2) is induced from the effect that “as for the proportion of autofluorescence in the noise of the whole observation optical system (or photometry optical system) of the optical system, it was around 30 percent in case of the objective lens; it was around 30 percent about the immersion substance; it was about 30 percent in case of the cover glass”, and as for the objective lens, the immersion substance, and the cover glass, each proportion of the noise in the optical system is the same as mentioned before; and by replacing the rate of the noise of the objective lens and the autofluorescence of the immersion substance out of noises in the autofluorescence from the optical system to the rate of the noise of the autofluorescence of the cover glass by using the condition (3-2′).

In the fluorescence observation or the fluorescence photometry method using the optical base material having low autofluorescence and good adhesive property to cell of the present invention, it is desired that the sample which emits the fluorescence using a living cell, and is selected by said process (A) satisfies at least one of the following conditions (2-3) and (3-3):

(S−s)/(B+b)≦2 (2-3)

3B_{CG}/B≧0.6 (3-3)

where S is an average value of the intensity of the fluorescence emitted from said sample, s is a fluctuation width of the intensity of said fluorescence, B is an average value of the intensity of the background noise where the sample does not exist, b is a fluctuation width of the intensity of the background noise, and B_{CG} is an average value of the intensity of the autofluorescence of the cover glass generally used conventionally.

Upper limit of the condition (2-3) mentioned above is made to correspond to the S/N ratio of application which is required when carrying out the fluorescence observation and/or fluorescence photometry for “single molecule” in the ranking of the brightness of the sample as mentioned above. Lower limit of the condition (3-3) mentioned above is made to correspond to the condition (3′-3) about “sample washed very cleanly” in the rate of the noise of the autofluorescence from the optical system to the whole noises, as mentioned above. The left side of the condition (3-3) is induced from the effect that “as for the proportion of autofluorescence in the noise of the whole observation optical system (or photometry optical system) of the optical system, it was around 30 percent in case of the objective lens; it was around 30 percent about the immersion substance; it was about 30 percent in case of the cover glass.” and as for the objective lens, the immersion substance, and the cover glass, each proportion of the noise in the optical system is the same as mentioned before; and by replacing the rate of the noise of the objective lens and the autofluorescence of the immersion substance out of noises in the autofluorescence from the optical system to the rate of the noise of the autofluorescence of the cover glass by using the condition (3′-1).

In the fluorescence observation or the fluorescence photometry method using the optical base material having low autofluorescence and good adhesive property to cell of the present invention, it is desired that the application selected by said process (B) is FRET. In the fluorescence observation or the fluorescence photometry method using the optical base material having low autofluorescence and good adhesive property to cell of the present invention, it is desired that the system selected by said process (B) is fluorescence microscope system. In the fluorescence observation or the fluorescence photometry method using the optical base material having low autofluorescence and good adhesive property to cell of the present invention, it is desired that the system selected by said process (B) is total reflection microscope system. In the fluorescence observation or the fluorescence photometry method using the optical base material having low autofluorescence and good adhesive property to cell of the present invention, it is desirable to constitute such that the system selected by said process (B) has both of the fluorescence microscope and the total reflection microscope, or two fluorescence microscopes, or two total reflection microscopes, wherein the objective optical systems are arranged to be faced on both sides of said sample as a microscope system.

And, by using the optical base material having low autofluorescence and good adhesive property to cell in the present invention, signals obtained from the cell increase. Accordingly, accuracy of the fluorescence observation and/or the fluorescence measurement can be made highly precise. Furthermore, even when using a component generating somewhat big noise of autofluorescence in an optical element, such as the objective lens, immersion substance and the like, by improvement in the signal value by having used the optical base material having low autofluorescence and good adhesive property to cell according to the present invention, the fluorescence observation and/or the fluorescence measurement can be carried out precisely, if the value shown by (S−s)/(B+b) is maintained to be less than the upper limit of each condition mentioned above, namely, the value is less than 2 (condition (2-3)), 3 (condition (2-2)), and 5 (condition (2-1)).

In the present invention a high refraction range is defined as a domain where refractive index nd in d line is within the following range:

1.6≦nd≦1.9

In the fluorescence observation or the fluorescence photometry system using the optical base material having low autofluorescence and good adhesive property to cell of the present invention, an optical element having low autofluorescence and good adhesive property to cell, and the following optical property is used in the high refraction range:

1.6≦nd≦1.9

35≦νd≦65

where nd is refractive index in d line, and νd is Abbe number in d line.

If the refractive index nd in d line of the optical base material is less than the lower limit (1.6), even if design is devised, numerical aperture NA of around 1.49 is only obtained. Actually, in a design using a cover glass with refractive index 1.52 numerical aperture NA is limited about NA=1.49. However, numerical aperture NA that is wanted for an application, such as the single molecule fluorescence observation and/or the fluorescence measurement, is more 1.5, namely NA≧1.49; for example such as 2, and the larger the value is, the more it is desirable. Therefore, if refractive index nd in d line of the optical base material is not 1.6 or more, it is not suitable as an application for fluorescence-measurement and/or fluorescence observation of single molecule. If an optical base material with refractive index nd (around 1.8) in d line is used, NA about 1.7 can be obtained. If an optical base material with refractive index nd (around 1.9) in d line is used, NA about 1.8 can be obtained.

Even if NA beyond such value mentioned above can be obtained, there is no immersion substance which complies with such value, and is substantially transparent and harmless, and does not have a problem, such as volatility. And from the viewpoint of giving degree of freedom of the design enabling to respond to the numerous kinds of optical glass, desirable range of the refractive index nd in d line of the optical base material is as follows:

1.6≦nd≦1.9

in particular, preferably

1.7≦nd≦1.8

Furthermore, at a result of examination, the inventor has found that observation and/or measurement can be made with sufficient accuracy in the following conditions;

35≦νd≦65

in particular, preferably

40≦νd≦60

where νd is Abbe number in d line of the optical base material.

In the present invention a low refraction domain is defined as a domain where refractive index nd at d line is within the following range: 1.35≦nd≦1.5. In the fluorescence observation and/or measurement system using the optical base material having low autofluorescence and good adhesive property to cell of the present invention, the inventor has found that observation and/or measurement can be made with sufficient accuracy in the following conditions: in a low refraction range refractive index nd in d line is 1.6≦nd≦1.9, in particular, preferably 1.37≦nd≦1.48. Furthermore, the inventor has found that the observation and/or measurement can be made with sufficient accuracy in the following conditions:

30≦νd≦100

in particular, preferably

35≦νd≦75

where νd is Abbe number in d line.

In an observation and/or a measuring device using objective lens, oil, and cover glass with low refractive index, there is a case that total reflection condition may not be satisfied. On the other hand, in an observation and/or a measuring device using objective lens, oil, and cover glass with high refractive index, it is easy to satisfy the total reflection condition comparing to a case of the observation and/or measuring apparatus using objective lens, oil, and cover glass with low refractive index. Therefore, it is suitable as an application for fluorescence-measurement and/or fluorescence observation of single molecule as mentioned above, etc. In the optical base material used for the fluorescence observation and/or measurement system of the present invention, silane coupling reagent having positive charge, and containing amino group is coated to the base surface in order to give good cell adhesion.

In the optical base material used for the fluorescence observation and/or measurement system of the present invention, generally, glass or plastics having the optical characteristics mentioned above is used as a material of the base material to which silane coupling reagent having positive charge, and containing amino group is coated. As long as a material has the optical characteristics mentioned above, besides the glass and plastics any material having permeability to a desired wavelength, such as crystal material can be used.

In the optical base material used for the fluorescence observation and/or measurement system of the present invention, as a suitable nitric material for production of the base material mentioned above, various nitric materials satisfying the optical characteristics mentioned above are illustrated as follows. For example, for glass base material, glass product made by the Ohara Glass Co., such as SCHOTT D263 and B270, etc.; as a material having refractive index generally used as an optical glass, S-BSL7 made by the Ohara Co.; and as a material having high refractive index, S-PFL53 made by the Ohara Co., and the like. Since all of these have not been usually used for cover glass or dish, it is necessary to process into suitable form.

As a material having refractive index often used when the base material mentioned above is produced by plastics, the followings may be used: Polystyrene; polycarbonate; polyester; polyvinyl chloride; cycloolefin polymer; acrylic resin; and fluorocarbon polymers etc., as a material having low refractive index.

A shape of the optical element having low autofluorescence and good adhesive property to cell according to the present invention is not limited in a specific shape. The followings can be used: for example, cover glass, plate, sheet, dish, flat cell, etc.

The production method of the optical base material having low autofluorescence and good adhesive property to cell used for the fluorescence observation and/or measurement system of the present invention, comprises a process for coating the silane coupling reagent where surface charge is positive onto the surface of the base material and satisfies the optical characteristics mentioned above. As a coating method of the silane coupling reagent, a method that solution of the silane coupling reagent is contacted to a base material surface, a method that mixed solution of the silane coupling reagent and polymer is contacted to the base material surface, a method that solution of the silane coupling reagent is contacted to the base material surface after preparing an intermediate layer in the base material surface, etc., can be used.

Here, it is desired that the method that solution of the silane coupling reagent is contacted to a base material surface is used when the base material which satisfies the optical characteristics mentioned above is glass. On the other hand, when the base material which satisfies the optical characteristics mentioned above is plastics, any of the method mentioned above can be used. However, it is desirable to use particularly, the method that mixed solution of the silane coupling reagent and polymer is contacted to the base material surface, or the method that solution of the silane coupling reagent is contacted to the base material surface after preparing an intermediate layer in the base material surface. Here, it is desired that the base material to be coated with the silane coupling reagent is fully washed before coating. Through the washing process, an organic substance that brings unfavorable effects in the fluorescence observation and/or measurement can be removed. As for the washing method, it is not limited specifically as long as the coating can be made efficiently. The following washing methods can be used: for example, acid washing, alkali washing, liquid washing by pure water etc.; and, furthermore, for example, processing by using plasma such as low-temperature oxygen plasma, low-temperature air plasma, corona discharge etc., can be used.

Furthermore, as for the glass that is used for the base material which satisfies the optical characteristics mentioned above, its zeta potential on the surface is comparatively big minus in many cases. And, when the washing as mentioned above is carried out, This tendency becomes strong. For example, it is easy to have the values, such as −100 mv. On the other hand, as for growth of the cell on the surface of the base material, in general, a cell grows easily in case that zeta potential is approaching plus. Namely, the washing process mentioned above, becomes a cause which worsens the growth of the cell on the glass base. However, if the silane coupling reagent with positive surface charge is coated onto the glass base material, the zeta potential of the base surface can become toward positive (plus) value, for example, from −100 mv to −30 mv, or 10 mv so that the zeta potential on the base surface may not have a big minus value even if the base material is washed. Accordingly, a growth rate of the cell is improved compared with a case of the glass base material where the silane coupling reagent that does not have positive surface charge is not coated.

As a silane coupling reagent used by the present invention, it is not limited specifically, and it can be used, as long as it is anything that the positive charge can be given onto the surface of the optical base material having low autofluorescence and good adhesive property to cell of the present invention. Concretely, the followings can be used for example;
(3-aminopropyl)trimethoxysilane;
(3-aminopropyl)triethoxysilane;
[3-(methylamino)propyl]trimethoxysilane;
[3-(N,N-dimethylamino)propyl]trimethoxysilane;
[3-(N,N-diethyl amino)propyl]trimethoxysilane;
3[N,N-bis(2-hydroxyethyl)amino]propyltriethoxysilane;
(3-aninopropyl)trimethoxysilane;
[3-(2-imidazolin-1yl)propyl]triethoxysilane;
trimethyl[3-(triethoxysilyl)propyl]ammonium chloride;
dimethyloctadecyl[3-(trimethoxysilyl)propyl]ammonium chloride;
[3-(2-aminoethylamino)propyl]trimethoxysilane;
[3-(2-aminoethylamino)propyl]trimethoxysilane;
N-3-(trimethoxysililepropyl)-N′-(4-vinylbenzyl)ethylenediamine hydrochloride;
3-(2-(2-aminoethylamino)ethylamino)propyltrimethoxysilane;
bis[3-(trimethoxysilyl)propyl]amine;
bis[3-(triethoxysilyl)propyl]amine;
(3-aminopropyl)diethoxymethylsilane,
3-aminopropylethoxydimethylamine, and
3-(2-aminoethylamino)propyldimethoxymethylsilane, etc.

When using a method such that solution of a silane coupling reagent is contacted to a base material surface, a solvent of the solution is not be limited specifically, as long as it enables to dissolve the silane coupling reagent stably. For example, the followings can be used: water, methanol, ethanol, 2-propanol, 1-butanol, 2-methoxyethanol, 2-ethoxyethanol, benzene, toluene, xylene, acetone, methyl ethyl ketone, methyl isobutyl ketone, ethyl acetate, butyl acetate, tetrahydrofuran, 1,4-dioxane, 1,2-dimethoxyethane, methylene chloride, chloroform, 1,2-dichloroethane, and a solvent having mixed these mentioned above at an arbitrary rate can be used.

However, it is desirable to use especially ethanol aqueous solution 90 to 99%. As for concentration of the solution of the silane coupling reagent, preferably, it is 0.1˜5%, and more preferably, 1˜3%. As for a time that solution of the silane coupling reagent is contacted to a base material surface, preferably, it is 1 minute˜24 hours, and more preferably, 10 minutes˜2 hours. As for a temperature that solution of the silane coupling reagent is contacted to a base material surface, preferably, it is 0˜150° C., and more preferably, 20˜30° C.

When using a method that mixed solution of the silane coupling reagent and polymer is contacted to the base material surface, it is desired that polymer has high affinity with the base material. The followings can be used: for example, polystyrene, polycarbonate (PC), and polyester, polyvinyl chloride, cycloolefin-polymer, acrylic resin, fluorocarbon polymers, nylon, polyethylene, polypropylene, and the like.

As for a solvent of the solution, it is not be limited specifically, as long as it enables to dissolve the silane coupling reagent and the polymer together, stably. The followings can be used: for example, ethyl acetate; butyl acetate; tetrahydrofuran; 1,4dioxane; 1,2-dichloroethane; methylene chloride; chloroform; 1,2dichloroethane; and a solvent having mixed these mentioned above at a desired rate.

When using a method that solution of the silane coupling reagent is contacted to the base material surface after preparing an intermediate layer in the base material surface, it is desired that material of intermediate layer has high affinity with the base material. The followings can be used: for example, polystyrene; polycarbonate (PC); polyester; polyvinyl chloride; cycloolefin polymer; acrylic resin; fluorocarbon polymers; nylon; polyethylene; polypropylene; and the like.

Method of forming the intermediate layer is not limited specifically. For example, spin coating, dip coating etc., can be used.

The optical element having low autofluorescence and good adhesive property to cell according to the present invention, further, can be processed for hardening after the silane coupling reagent was coated on the surface of the base material as mentioned above. The hardening processing conditions are not limited specifically. However, it is desired that Processing temperature is 120˜200° C., and processing time is 10 minutes˜2 hours. The optical element having low autofluorescence and good adhesive property to cell according to the present invention, can be processed for sterilization just before use of it. As the sterilization-processing method, such as gamma ray sterilization, electron beam sterilization, radiation sterilization methods, such as X ray sterilization, EOG (ethylene oxide gas) sterilization having excellent osmosis power at low temperature, high temperature dry sterilization, high pressure steam sterilization etc., can be used. In order to avoid complicated operation, and deterioration of plastics, radiation sterilization is used generally in many cases

As for the cell which serves as the examined object in the present invention, the followings are generally used: Hela, NG, PC12, CHO, COS, NIH3T3, and the like.

The degree of adhesion in the base material of these cells is various. For example, NG cell does not adhere to the base material easily compared with Hela cell.

Next, explanation will be made about methods of fluorescence observation and/or measurement using the fluorescence observation and/or measurement system using the optical base material having low autofluorescence and good adhesive property to cell of the present invention.

As a microscope used for the fluorescence observation of the present invention, any erected type or inverted type fluorescence microscope can be used. As an objective lens, an immersion substance, a cover glass and a slide glass, it is good to use an objective lens using a low autofluorescence optical glass, a low autofluorescence immersion oil, a cover glass constituted as an optical element having low autofluorescence and good adhesive property to cell according to the present invention, or a low autofluorescence slide glass.

In case of an application for observing a cell having thickness, or an application for observing a sample containing glycerol, as an application in the low refraction domain, a glycerin objective lens is used. The immersion liquid of the glycerin objective lens is prepared by glycerol plus water, where the refractive index is prepared to 1.44-1.48. As for a thickness of the cover glass, in general, there is a variation ranging from several tens to several hundreds microns in many cases. Accordingly, when using the water and the glycerin objective lens, it is good to use a correction collar objective corresponding to the thickness of the cover glass.

In order to measure evanescent light in the system of the present invention, it is constituted such that an illumination optical system having the following constitution is used. Namely, the illumination optical system has for example, a laser light source, an introductory optical system for introducing laser light oscillated from the laser light source to an optical fiber, an illumination optical system for irradiating light from the optical fiber to the sample, and a mechanism by which an arrangement (position) of the optical fiber can be adjusted from the optical axis to the position in which the evanescent illumination can be carried out. (a position deviated from the optical axis) As a laser light source used when measuring the evanescent light, usually, blue laser (argon laser, wavelength of 488 nm), and green laser (helium-Ne green, wavelength of 543 nm), and (the second harmonics of YAG 1064 nm, wavelength of 532 nm) are used.

Hereafter, embodiments of the fluorescence observation and/or measurement system using the optical base material having low autofluorescence and good adhesive property to cell of the present invention will be explained concretely. The present invention is not limited to such embodiments.

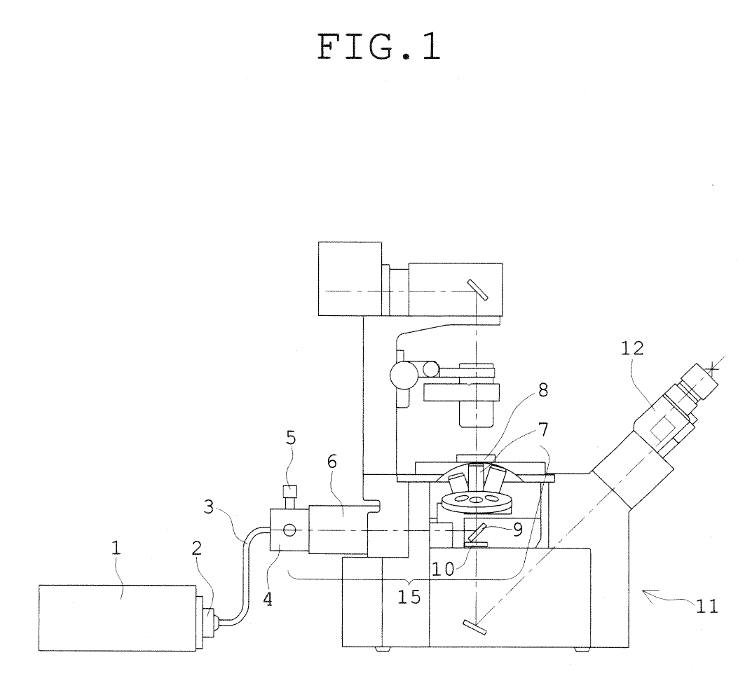

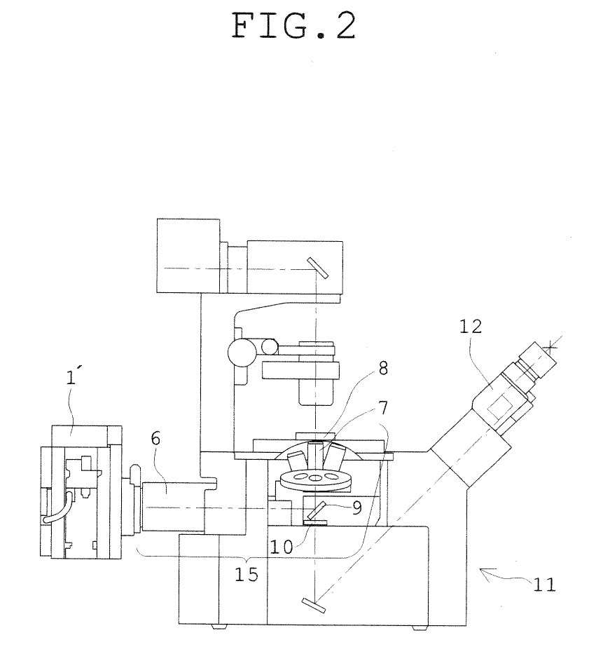

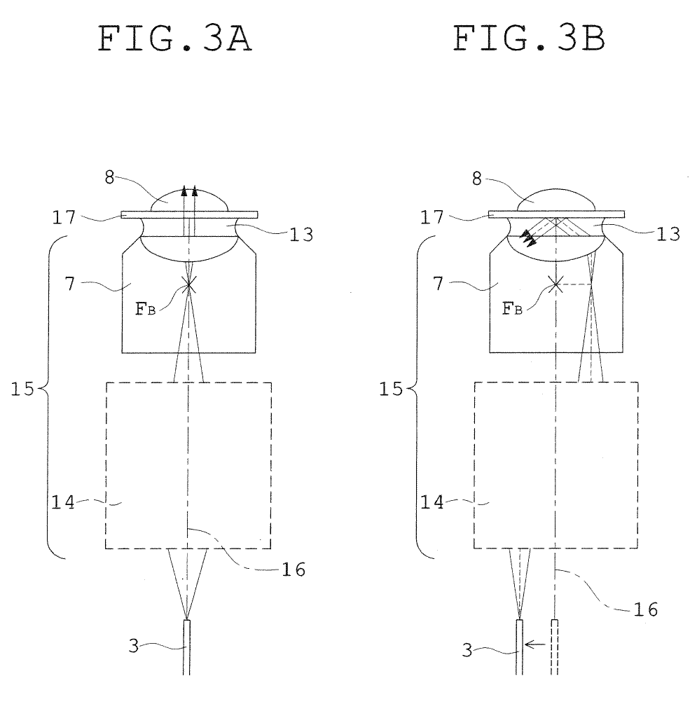

Firstly, an example of constitution of a conventional fluorescence microscope apparatus used in the embodiment and the comparative example of the fluorescence observation and/or fluorescence photometry system of the present invention will be shown. FIGS. 1 and 2 are side views showing an example of composition of a conventional erect type fluorescence microscope apparatus. FIG. 1 is an outline figure of a vertical light fluorescence microscope apparatus using a laser light source, FIG. 2 is an outline figure of a vertical light fluorescence microscope apparatus using a white arc light source. FIGS. 3A and 3B are outline figures showing arrangement of a principal part of the illumination light optical system in the fluorescence microscope apparatus of FIG. 1, an arrangement of the optical element at the time of usual fluorescence observation, and an arrangement of the optical element at the time of total reflection fluorescence observation, respectively. For convenience sake, explanation of the microscope apparatus of FIG. 1 will be made here. In the microscope apparatus of FIG. 2, arc source 1′ for the light source part is connected to a vertical light projection pipe 6 directly. However, except the portion mentioned above, the other composition is almost the same as the microscope apparatus of FIG. 1.

The fluorescence microscope apparatus shown in FIG. 1, is constituted as a microscope equipped with illumination optical system having a laser light source 1, a laser introduction mechanism 2 equipped with an introductory optical system for introducing laser light oscillated from the laser light source 1 to an optical fiber 3, an optical component from a vertical light projection pipe 6 to an objective lens 7, as an illumination optical system for irradiating the light emanated from the optical fiber 3 to the sample 8, an adaptor as a mechanism by which an arrangement (position) of the optical fiber 3 can be adjusted from the optical axis to a designated position in which the evanescent illumination can be carried out. (a position deviated from the optical axis), and an optical fiber position adjustment knob 5. In FIG. 1, 9 represents a dichroic mirror; 10 represents a absorption filter; 11 represents a main part of the microscope; and 12 represents an observation body.

An illumination optical system 15, has an objective lens 7 arranged at the sample 8 side and a condenser 14 arranged at the optical fiber 3 side (for example, the vertical light projection pipe 6) as shown in FIGS. 3A and 3B. In FIGS. 3A and 3B, 16 is an optical axis and 17 is a cover glasses 16. FB is a backside focal position of the objective lens 7. In FIGS. 3A and 3B, for convenience sake, the dichroic mirror 9 is omitted, and an portion from the optical fiber 3 to the objective lens 7 is shown linearly. The condenser lens 14 is constituted so that the light emitted from the optical fiber 3 may be condensed at the backside focal position of the objective lens 7 or its neighborhood

The adapter 4 is constituted so that it may be connected to the vertical light projection pipe 6 and an exit end of the optical fiber 3, and the laser light emitted from the optical fiber 3 may be led to the vertical light projection pipe 6. In the adapter 4, the exit end of the optical fiber 3 is held by the optical fiber position adjustment knob 5. In the inside of the adapter 4, a well-known mechanism is arranged, wherein by operating the fiber position adjustment knob 5 from the exterior side, the exit end of the optical fiber 3 may be moved along the optical axis (refer to FIG. 3A), or to a position (refer to FIG. 3B) deviated by a designated amount from the optical axis to which the evanescent illumination can be made. Then, the microscope in FIG. 1, is constituted so that by operating the fiber position adjustment knob 5 from the exterior sides a normal epi-illumination in which the optical fiber 3 is located on the optical axis of the illumination optical system (refer to FIG. 3A), and a total reflection illumination in which the optical fiber 3 is located far from the optical axis of the illumination optical system by a designated distance (refer to FIG. 3B) may be switched. The immersion substance 13 is filled between the objective 7 and the sample 8.

Next, the fluorescence observation or the fluorescence photometry system in this embodiment and the comparative example of the present invention will be shown. Fundamental outline constitution of the fluorescence microscope apparatus in the fluorescence observation or the fluorescence photometry system in this embodiment and the comparative example of the present invention is the same as the conventional fluorescence microscope apparatus shown in FIGS. 1 and 2. In the following explanation, only a constitution part of which description differs between the embodiment and the comparative example will be explained, and the explanation about the same constitution part will be omitted.

### Embodiment 1

The optical base material having low autofluorescence and good adhesive property to cell, which is used as a cover glass for the fluorescence observation and/or measurement system of the embodiment 1 is produced by the following steps.

An optical glass block having an optical property such that refractive index nd in d line is nd≧1.77, and Abbe number νd=50 in d line (Product made by the Ohara Co. S-LAH66) was purchased. Then, it was polished, and 81 sheets of glass plates that were 18 mm in length, 18 mm in width, and 0.15 mm in thickness were produced. Then, the produced glass plates were immersed in water solution of potassium hydroxide of 0.1 mol/L, and ultrasonic washing was carried out for 20 minutes at the room temperature, and then these were kept calmly as these were overnight. Then, again, the ultrasonic washing was carried out for 20 minutes at the room temperature, and then these were washed by distilled water. Furthermore, these were immersed in ethanol, and the ultrasonic washing was carried out for 20 minutes at the room temperature, and these were kept calmly for 2 hours. Then, these were dried by air flow in a clean bench. The 81 sheets of air-dried glass plates were immersed in ethanol of 2000 ml, and [3-(2-aminoethylamino)propyl]trimethoxysilane, 4.0 g shown by the following constitutional formula (CHEM. 1), and distilled water 60 mL were added, and agitated at the room temperature for 17 hours. Then, reaction liquid was removed, ethanol 2000 mL was added, and these were agitated for 3 hours. Then, these glass plates were taken out, and air drying was done in the clean bench.

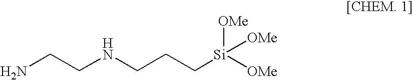

NG cell was grown on the optical base material having low autofluorescence and good adhesive property to cell, which was produced by the procedure mentioned above, and by using Alexa Fluor 488 which is a fluorescence reagent, the cell was dyed. Then, it was observed using the fluorescence microscope apparatus shown in FIGS. 1 and 2.

At this time, in order to observe weaker fluorescence by enlarging NA of the observation optical system, an objective lens, (Apo 100-HR (NA1.65), made by OLYMPUS Co.), an immersion substance, (refractive index 1.78 made by Cargille Co.), an inverted type microscope (IX71 made by OLYMPUS Co.), and a detecting device (EM-CCD made by Hamamatsu Photonics Co.) were used, and single molecule fluorescence observation by ordinary vertical fluorescence was carried out. The optical base material of the embodiment 1 has the same refractive index as that of the cover glass produced by polishing glass S-LAH66 made by OHARA Co. (refractive index 1.77), and the Abbe number in comparative example 2 mentioned later, and the ratio of the autofluorescence satisfies condition (1-1). Namely, when the autofluorescence of the cover glass of the first embodiment represents B′_{CG} and the autofluorescence of the cover glass used in the comparative example 1 represents B_{CG}, it satisfies B_{CG′}/B_{CG}≦0.7.

Here, not only the ordinary fluorescence observation but also the total reflection fluorescence observation by the total reflection fluorescence observation apparatus shown in FIGS. 3A and 3B were carried out. Furthermore, FRET and animation observation were also carried out. This sample satisfies condition (2-3) mentioned above (namely, (S−s)/(B+b)≦2), and the condition (3-3) (namely, 3B_{CG}/B≧0.6). In the fluorescence observation or the fluorescence photometry method using the optical base material having low autofluorescence and good adhesive property to cell of the embodiment 1, generating of the aberration was suppressed, growth of the cell was good, many signals of the observation object were obtained, S/N ratio was good, and highly precise observation was able to be achieved.

The optical base material having low autofluorescence and good adhesive property to cell, which is used as a cover glass for the fluorescence observation and/or measurement system of the embodiment 1 is not limited to a material having the ratio of the autofluorescence with the comparative example 2 satisfying the condition (1-1). For example, if condition (1-2) (namely, B_{CG′}/B_{CG}≦0.5) and the optical base material which satisfies condition (1-3) (namely, B_{CG′}/B_{CG}≦0.3) further are used, the improvement effect of the S/N ratio will become higher. The fluorescence observation and/or fluorescence photometry system of the embodiment 1 has been explained using the inverted type microscope. However, it is not limited to the inverted type microscope. The present invention can demonstrate the same effect also in an erected image type microscope.

As a microscope used for the present invention, it can be constituted as a up-and-down microscope in which an inverted type microscope and an erected image type microscope are arranged on both sides of a sample. In case of the up-and-down microscope, the effect of the present invention can be demonstrated if the cover glass shown in the embodiment of the present invention is used at one of the erect-image-microscope side or the inverted microscope side. As for the erect image type microscope side and the inverted microscope side, constitution for driving independently, or constitution for driving with interlocking may be used. Furthermore, different observation methods can be used by a microscope at upper side, and a microscope at below side; for example, an ordinary fluorescence observation is carried out at the erect image type microscope side, and a total reflection fluorescence observation is done at the inverted microscope side.

### COMPARATIVE EXAMPLE 1

The optical base material having low autofluorescence and good adhesive property to cell, which is used as a cover glass for the fluorescence observation and/or measurement system of the comparative example 1 was made by the following steps.

An optical glass block having an optical property such that refractive index nd in d line is d=1.53, and Abbe number νd=54 in d line (D-263 made by SHOTT Co.) was purchased. The optical glass block was polished, and 81 sheets of glass plates that were 18 mm in length, 18 mm in width, and 0.15 mm in thickness were produced. The produced glass plates were immersed in water solution of potassium hydroxide of 0.1 mol/L. Then, after ultrasonic washing was carried out for 20 minutes at the room temperature, these were kept calmly overnight as these were. Then, again, ultrasonic washing was carried out for 20 minutes at the room temperature, and then these were washed by distilled water. Furthermore, these were immersed in ethanol, and the ultrasonic washing was carried out for 20 minutes at the room temperature these were kept calmly for 2 hours. Then, these were dried by air flow in a clean bench.

NG cell was grown on the optical base material of the comparative example 1, which was produced by the steps mentioned above, and the fluorescence observation was tried like the embodiment 1 by using a fluorescence reagent, a microscope, an objective lens, an immersion substance, and a tester which were the same to those in the embodiment 1. In the fluorescence observation using the optical base material of the comparative example 1, an aberration occurred greatly according to the refractive index difference with the refractive index 1.78 of the objective lens, and the cell was unable to be observed.

### COMPARATIVE EXAMPLE 2

The optical base material having low autofluorescence and good adhesive property to cell, which is used as a cover glass for the fluorescence observation and/or measurement system of the comparative example 2 was made by the following steps.

An optical glass block having an optical property such that refractive index nd in d line is nd≦1.77, and Abbe number νd=50 in d line (Product made by the Ohara Co. S-LAH66) was purchased. The optical glass block was polished, and 81 sheets of glass plates that were 18 mm in length, 18 mm in width, and 0.15 mm in thickness were produced. The produced glass plate was used as it was without having washed, as the optical base material of the comparative example 2. NG cell was grown on the optical base material of the comparative example 2, and the fluorescence observation was tried like the embodiment 1 by using a fluorescence reagent, a microscope, an objective lens, an immersion substance, and a tester which were the same to these in the embodiment 1. In the fluorescence observation using the optical base material of the comparative example 2, adhesion of the cell was bad, and there were few signals of the fluorescence acquired and the observation image was unable to be seen easily.

### COMPARATIVE EXAMPLE 3

The optical base material having low autofluorescence and good adhesive property to cell, which is used as a cover glass for the fluorescence observation and/or measurement system of the comparative example 3 was made by the following steps.

An optical glass block having an optical property such that refractive index nd in d line is nd≦1.77, and Abbe number νd=50 in d line (Product made by the Ohara Co. S-LAH66) was purchased. Then, the optical glass block was polished, and 81 sheets of glass plates that were 18 mm in length 18 mm in width, and 0.15 mm in thickness were produced. The produced glass plates were immersed in water solution of potassium hydroxide of 0.1 mol/L, ultrasonic washing was carried out for 20 minutes at the room temperature, and then these were kept calmly, as these were, overnight. Then again, the ultrasonic washing was carried out for 20 minutes at the room temperature, and then these were washed by distilled water. Furthermore, these were immersed in ethanol, and the ultrasonic washing was carried out for 20 minutes at the room temperature, and these were kept calmly for 2 hours. Then, these were dried by air flow in a clean bench.

NG cell was grown on the optical base material of the comparative example 3, which was produced by the procedure mentioned above, and the fluorescence observation was tried like the embodiment 1 by using a fluorescence reagent, a microscope, an objective lens, an immersion substance, and a tester which were the same to these in the embodiment 1. In the fluorescence observation using the optical base material of the comparative example 3, adhesion of the cell was bad, there were few signals of the fluorescence acquired and the observation image was unable to be seen easily.

### COMPARATIVE EXAMPLE 4

The optical base material having low autofluorescence and good adhesive property to cell, which is used as a cover glass for the fluorescence observation and/or measurement system of the comparative example 4 was made by the following steps. An optical glass block having an optical property such that refractive index nd in d line is nd≦1.77, and Abbe number νd=50 in d line (Product made by the Ohara Co. S-LAH66) was purchased. Then, the optical glass block was polished, and 81 sheets of glass plates that were 18 mm in length, 18 mm in width, and 0.15 mm in thickness were produced. The produced glass plates were immersed in the neutral detergent, and the ultrasonic washing was carried out for 20 minutes at the room temperature, and then these were immersed in the concentrated sulfuric acid, and kept calmly as these were overnight. Then, these were washed by distilled water. Furthermore, these were immersed in ethanol, and the ultrasonic washing was carried out for 20 minutes at the room temperature, these were kept calmly for 2 hours. Then, these were dried by air flow in a clean bench. NG cell was grown on the optical base material of the comparative example 4, which was produced by the steps mentioned above, the fluorescence observation was tried like the embodiment 1 by using a fluorescence reagent, a microscope, an objective lens, an immersion substance, and a tester which were the same to these in the embodiment 1. In the fluorescence observation using the optical base material of the comparative example 4, adhesion of the cell was bad, and there were few signals of the fluorescence acquired and the observation image was unable to be seen easily.

### Embodiment 2

The optical base material having low autofluorescence and good adhesive property to cell, which is used as a cover glass for the fluorescence observation and/or measurement system of the embodiment 2 was produced by the following steps. 81 sheets of glass plates that were 18 mm in length, 18 mm in width, and 0.5 mm in thickness were produced and air-dried by the same steps as shown in the embodiment 1 were immersed in ethanol 700 mL, and then 3-aminopropyltriethoxysilane, 2.0 g shown by the following constitutional formula (CHE 2), and distilled water 20 mL were added. Then these were agitated at the room temperature for 17 hours. Then, reaction liquid was removed, ethanol 700 mL was added, and these were agitated for 3 hours. Then, these glass plates were taken out, and air drying was done in the clean bench.

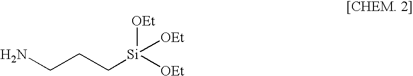

Hela cell was grown on the optical base material of the embodiment 2, which was produced by the steps mentioned above, and the fluorescence observation was carried out like in the embodiment 1 by using a fluorescence reagent, a microscope, an objective lens, an immersion substance, and a tester which were the same to these in the embodiment 1. In the fluorescence observation of a living thing using the optical base material having low autofluorescence and good adhesive property to a cell of the embodiment 2, generating of the aberration was suppressed, growth of the cell was good, many signals of the observation object were acquired, S/N ratio was good, and highly precise observation was able to be achieved.

### Embodiment 3

The optical base material having low autofluorescence and good adhesive property to cell, which was used as a cover glass for the fluorescence observation and/or measurement system of the embodiment 3 was produced by the following steps. An optical glass block having an optical property such that refractive index nd in d line is nd=1.53, and Abbe number νd=54 in d line (D-263 made by SHOTT Co.) was purchased. The optical glass block was polished, and 81 sheets of glass plates that were 18mm in length, 18 mm in width, and 0.5 mm in thickness were produced. the produced glass plates were immersed in water solution of potassium hydroxide of 0.1 mol/L, ultrasonic washing was carried out for 20 minutes at the room temperature, and then kept calmly overnight as these were. Then again, the ultrasonic washing was carried out for 20 minutes at the room temperature, and then these were washed by distilled water Furthermore, these were immersed in ethanol, and the ultrasonic washing was carried out for 20 minutes at the room temperature, these were kept calmly for 2 hours. Then, these were dried by air flow in a clean bench. 81 sheets of air-dried glass plates were immersed in ethanol 2000 mL, [3-(2-aminoethylamino)propyl]trimethoxysilane, 4.0 g and distilled water 60 mL were added, and agitated at the room temperature for 17 hours. Then, reaction liquid was removed, ethanol 2000 mL was added, and these were agitated for 3 hours. Then, these glass plates were taken out, and air drying was done in the clean bench.

NG cell was grown on the optical base material of the embodiment 3, having low autofluorescence and good adhesive property to cell, which was produced by the steps mentioned above. Except for having used UPLSAP60-XO (made by Olympus Co.) as an objective lens, the fluorescence observation was carried out like in the embodiment 1.by using a fluorescence reagent, a microscope, an objective lens, immersion substance, and a tester which were the same to those in the embodiment 1. In the fluorescence observation using the optical base material having low autofluorescence and good adhesive property to cell of the embodiment 3, growth of the cell was good, many signals of the observation object were acquired, S/N ratio was good, and highly precise observation was able to be achieved.

### Embodiment 4

The optical base material having low autofluorescence and good adhesive property to cell, which is used as a cover glass for the fluorescence observation and/or measurement system of the embodiment 4 was produced by the following steps. 81 sheets of glass plates that were 18 mm in length, 18 mm in width, and 0.15 mm in thickness were produced and air-dried by the same steps as shown in the embodiment 3. These were immersed in ethanol 700 mL, and 3[3-(2-aminoethylamino)ethylamino]propyl]trimethoxysilane, 4.0 g shown by the following constitutional formula (CHE 3), and distilled water 20 mL were added, and these were agitated at the room temperature for 17 hours. Then, reaction liquid was removed, ethanol 700 mL was added, and these were agitated for 3 hours. Then, these glass plates were taken out and air drying was done in the clean bench.

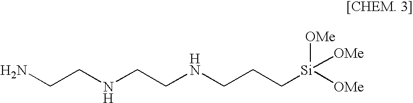

NG cell was grown on the optical base material of the embodiment 4, having low autofluorescence and good adhesive property to cell, which was produced by the steps mentioned above. Fluorescence observation was carried out like in the embodiment 1 by using a fluorescence reagent, a microscope, an objective lens, an immersion substance, and a tester which were the same to those in the embodiment 3. In the fluorescence observation using the optical base material having low autofluorescence and good adhesive property to cell of the embodiment 4, growth of the cell was good, many signals of the observation object were acquired, S/N ratio was good, and highly precise observation was able to be achieved.

### Embodiment 5

The optical base material having low autofluorescence and good adhesive property to cell, which is used as a cover glass for the fluorescence observation and/or measurement system of the embodiment 5 was produced by the following steps. Polystyrene pellet 30 g was dissolved in acetone 700 mL 81 sheets of glass plates that were 22 mm in length, 22 mm in width, and 0.20 mm in thickness were washed on the surfaces by low-temperature oxygen plasma, and hydrophilic property was given on these. These 81 sheets of polyvinyl chloride plates which were washed and had hydrophilic property were immersed in the solution mentioned above, and [3-(2-aminoethylamino)propyl]trimethoxysilane, 4.0 g and distilled water 2 mL were added, and these were agitated at the room temperature for 17 hours. Then, these polyvinyl chloride plates were taken out from the reaction liquid, and air drying was done in the clean bench. Then, these were immersed in ethanol 700, and agitated for 3 hours. Then, these polyvinyl chloride plates were taken out, and air drying was done in the clean bench.

NG cell was grown on the optical base material of the embodiment 5, having low autofluorescence and good adhesive property to cell, which was produced by the steps mentioned above, and the fluorescence observation was carried out like in the embodiment 1 by using a fluorescence reagent, a microscope, an objective lens, an immersion substance, and a tester which were the same to the embodiment 3. In the fluorescence observation using the optical base material having low autofluorescence and good adhesive property to cell of the embodiment 5, growth of the cell was good, many signals of the observation object were acquired, S/N ratio was good, and highly precise observation was able to be achieved.

### COMPARATIVE EXAMPLE 5

Polyvinyl chloride plates that were 22 mm in length, 22 mm in width, and 0.20 mm in thickness were washed on the surfaces by low-temperature oxygen plasma, and hydrophilic property was given on these. The polyvinyl chloride plates mentioned above were used as the optical base material having low autofluorescence and good adhesive property to cell, which were used as a cover glass for the fluorescence observation and/or measurement system of the comparative example 5. NG cell was grown to the optical base material of the comparative example 5, which was produced by the steps mentioned above, and the fluorescence observation was tried like the embodiment 1 by using a fluorescence reagent, a microscope, an objective lens, an immersion substance, and a tester which were the same to the embodiment 3. In the fluorescence observation using the optical base material of the comparative example 5, adhesion of the cell was bad, and there were few signals of the fluorescence acquired and the observation image was unable to be seen easily.

### Embodiment 6

The optical base material having low autofluorescence and good adhesive property to cell, which is used as a cover glass for the fluorescence observation and/or measurement system of the embodiment 6 was produced by the following steps. A block of quartz glass (made by TOHSOH Co.) was purchased, and the block of quartz glass was polished, and 81 sheets of glass plates that were 18 mm in length, 18 mm in width, and 0.15 mm in thickness were produced. The produced glass plates were immersed in water solution of potassium hydroxide of 0.1 mol/L, washed by ultrasonic washing for 20 minutes at the room temperature, and then kept calmly overnight as these were. Then again, these were washed by the ultrasonic washing for 20 minutes at the room temperature, and then were washed by distilled water. Furthermore, these were immersed in ethanol, and the ultrasonic washing was carried out for 20 minutes at the room temperature, these were kept calmly for 2 hours. Then, these were dried by air flow in a clean bench. 81 sheets of quartz glass plates dried by air flow were immersed in ethanol 2000 mL, [3-(2-aminoethylamino)propyl]trimethoxysilane, 4.0 g and distilled water 60 mL were added, and these were agitated at the room temperature for 17 hours. Then, reaction liquid was removed, ethanol 2000 mL was added, and these were agitated for 3 hours. Then, these quartz glass plates were taken out, and air drying was done in the clean bench.

NG cell was grown on the optical base material of the embodiment 6, having low autofluorescence and good adhesive property to cell, which was produced by the steps mentioned above. Except for having used UPLSAP60-XW (made by Olympus Co.) as an objective lens, the fluorescence observation was carried out like in the embodiment 1 by using a fluorescence reagent, a microscope, an objective lens, an immersion substance, and a tester which were the same to the embodiment 1. Furthermore, correction was carried out by the correction ring when observation was carried out. In the fluorescence observation using the optical base material having low autofluorescence and good adhesive property to cell of the embodiment 6, generation of the aberration was suppressed, growth of the cell was good, many signals of the observation object were acquired, S/N ratio was good, and highly precise observation was able to be achieved.

### Embodiment 7

The optical base material having low autofluorescence and good adhesive property to cell, which is used as a cover glass for the fluorescence observation and/or measurement system of the embodiment 7 was produced by the following steps. 81 sheets of quartz glass plates that were 18 mm in length, 18 mm in width, and 0.15 mm in thickness were produced and dried with air by the same steps as shown in the embodiment 6. And, these were immersed in ethanol of 200 mL, [3-(N,N-dimethylamino)propyl]trimethoxysilane, 4.0 g shown by the following constitutional formula (CHE 4), and distilled water 60 mL were added, and these were agitated at the room temperature for 17 hours. Then, reaction liquid was removed, ethanol 2000 mL was added, and these were agitated for 3 hours. Then, these quartz glass plates were taken out, and air drying was done in the clean bench.

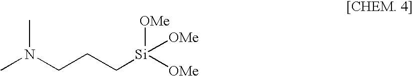

NG cell was grown on the optical base material of the embodiment 7, having low autofluorescence and good adhesive property to cell, which was produced by the steps mentioned above, the fluorescence observation was carried out like in the embodiment 1 by using a fluorescence reagent, a microscope, an objective lens, an immersion substance, and a tester which were the same to those in the embodiment 6. In the fluorescence observation using the optical base material having low autofluorescence and good adhesive property to cell of the embodiment 7, growth of the cell was good, many signals of the observation object were acquired, S/N ratio was good, and highly precise observation was able to be achieved.

### Embodiment 8

The optical base material having low autofluorescence and good adhesive property to cell, which is used as a cover glass for the fluorescence observation and/or measurement system of the embodiment 8 was produced by the following steps. 81 sheets of CYTOP base material that were 22 mm in length, 22 mm in width, and 0.20-mm in thickness (nd=1.35, νd=90), which were produced by drying and solidificating the CYTOP solution were washed on the surfaces by low-temperature oxygen plasma, and hydrophilic property was given on these. Further, pellets of 30 g of the CYTOP (made by Asahi Glass Co.) were dissolved in perfluoro-2-butyltetrahydrofran of 700 mL, [3-(2-aminoethylamino)propyl]trimethoxysilane, 4.0 g was added to this solution, and these were agitated at the room temperature for 3 hours, and solution that formed an intermediate layer was adjusted. In the solution forming this intermediate layer, 81 sheets of CYTOP base materials which were washed and given hydrophilic property as mentioned above were immersed for the 5 hours. Then, these CYTOP base materials were taken out from the reaction liquid, and air drying was done in the clean bench. Then, these were immersed in ethanol 700, and agitated for 3 hours. Then, these CYTOP base materials were taken out, and air drying was done in the clean bench. CYTOP base materials obtained had refractive index nd in d line of 1.34, and Abbe number in d line of about 90.

NG cell was grown on the optical base material of the embodiment 8, having low autofluorescence and good adhesive property to cell, which was produced by the steps mentioned above, the fluorescence observation was carried out like in the embodiment 1 by using a fluorescence reagent, a microscope, an objective lens, an immersion substance, and a tester which were the same to the embodiment 6. In the fluorescence observation using the optical base material having low autofluorescence and good adhesive property to cell of the embodiment 8, growth of the cell was good, many signals of the observation object were obtained, S/N ratio was good, and highly precise observation was able to be achieved.

### COMPARATIVE EXAMPLE 6

CYTOP base materials that were 22 mm in length, 22 mm in width, and 0.20-mm in thickness (nd=1.35, νd=90), which were produced by drying and solidificating the CYTOP solution were washed on the surfaces by low-temperature oxygen plasma, and given hydrophilic property. These were used as optical base materials having low autofluorescence and good adhesive property to cell, which were used as a cover glass for the fluorescence observation and/or measurement system of the comparative example 6. NG cell was grown on the optical base material of the comparative example 6, which was produced by the procedure mentioned above, and the fluorescence observation was tried like that in the embodiment 1 by using a fluorescence reagent, a microscope, an objective lens, an immersion substance, and a tester which were the same to these in the embodiment 6. In the fluorescence observation using the optical base material of the comparative example 6, adhesion of the cell was bad, and there were few signals of the fluorescence obtained and the observation image was unable to be seen easily.

### Embodiment 9

In the embodiment 9, by using the optical base material having low autofluorescence and good adhesive property to cell, which was produced like that in the embodiment 1, by a method of the fluorescence resonance energy movement (FRET), the calcium ion concentration in the cell was measured. Two fluorescence images of 485 nm and 530 nm were obtained by using the optical base material of the embodiment 9, having low autofluorescence and good adhesive property to cell, which was produced like that in the embodiment 1, wherein NG cell was grown on it, and cameleon (a fluorescent protein) was added; and a fluorescence microscope IX-71-SIPFRET (made by Olympus Co.) as a microscope, a super-high numerical aperture objective lens Apo100-OHR (made by Olympus Co.) as an objective lens; and a laser, and a single-mode fiber; and the same immersion substance and the tester as used in the embodiment 1 were used.

Cameleon has a structure in which two kinds of fluorescent proteins called CFP and YFP are connected to protein, such as Calmodulin M. In a state that calcium ion in a cell is low, only fluorescence of CFP of 485 nm is emitted when excitation light of 442 nm is irradiated. However, if the calcium ion concentration becomes high, energy transition takes place from CFP to YFP, and fluorescence of 530 nm that is the fluorescence of YFP is observed. The calcium ion concentration was measured by taking the ratio of fluorescence intensities of CFP and YFP.

In the fluorescence measurement using the optical base material having low autofluorescence and good adhesive property to cell of the embodiment 9, growth of the cell was good, many signals of the calcium ion concentration were obtained, S/N ratio was good, the light of the calcium ion concentration was able to be measured, and highly precise measurement was carried out.

### Comparison of Growth of the Cell

With respect to growth of the cell about the optical base material having low autofluorescence and good adhesive property to cell, which is used for the fluorescence observation and/or fluorescence photometry system in the embodiment 1 and the embodiment 2; and the optical base material which is used for the fluorescence observation and/or fluorescence photometry system in the comparative example 2 comparison was carried out as follows.

### Washing and Sterilization of the Base Material

After each optical base material was immersed in ethanol for 30 minutes, it was taken out. Then, the ethanol adhered on the surface of the optical base material was wiped off by lens cleaning paper. Then, it was put into an oven of 180° C., and dry sterilization was carried out about 2 hour.

### Cell Adhesion and Cultivation

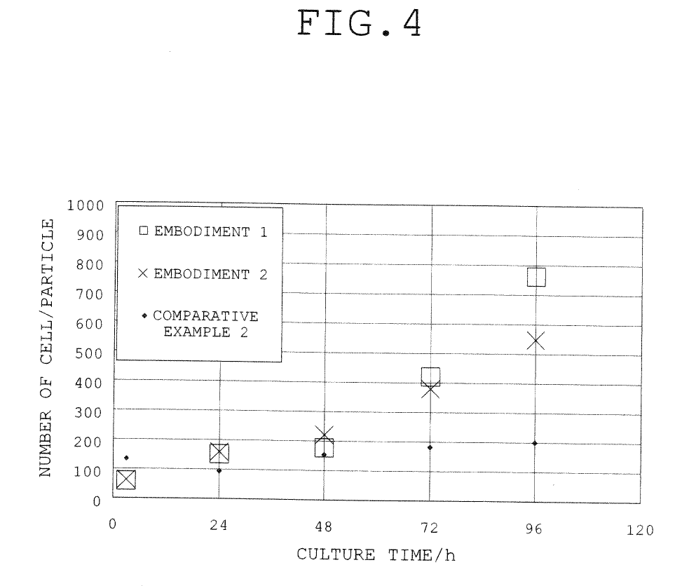

Each optical base material which the washing and sterilization processing mentioned above had been carried out were installed in the center of the insertion bole of a cell culture container 6 (made by BD falcon company), and cultivation solution (concentration=5×10 4cells/mL) containing NG cell was poured into it. At this time, in order to spread cells uniformly in the optical base material the container was shaken, and the cells were distributed. Then, a well having 6 holes was put into CO2 incubator (temperature 37° C., 5% of CO2 concentration), and adhesion and cultivation of the cell to an optical base material were carried out. In order to observe time check of change of adhesion and cultivation of the cell, the number of cells per unit area (area of the rectangle (1.7 mm×2.2 mm) near the center of the cover glass) was counted by using an optical microscope The timing of observation was set as 3 hours, 24 hours, 48 hours, 72 hours, and 96 hours. The number of adhesion cells in the time of cell culture in the timing of observation was shown in FIG. 4 As shown in FIG. 4, in case of the fluorescence observation using the optical base material having low autofluorescence and good adhesive property to cell in the embodiments 1 and 2, it is seen that growth of cells is improved in comparison with the case where the optical base material of the comparative example 2 was used.

### Measurement of Nitrogen Content

Nitrogen content of the optical base material having low autofluorescence and good adhesive property to cell, which is used for the fluorescence observation and/or fluorescence photometry system in the embodiments 1 and 2, was measured using electron gun micro analyzer JXA-8200 (made by JEOL Co., Ltd.). A measurement result is shown in the following table 1. In Table 1, as for the comparative example 2, the nitrogen content showing amino group is shown as 0 since the optical base material used for the fluorescence observation and/or fluorescence photometry system of the comparative example 2 consists of glass. On the other hand, in the optical base material having low autofluorescence and good adhesive property to cell in the embodiments 1 and 2, the amino group is adhered on it such as nitrogen content is 4.1% and 10.8%, respectively, by coating silane coupling reagent with positive surface charge on a surface of the glass plate. Thus, the substrate is reformed to have good adhesive property to cell.

TABLE 1

| Sample | nitrogen content (%) |
|---|---|
| optical base material | 4.1 |
| of the embodiment 1 | |
| optical base material | 10.8 |
| of the embodiment 2 | |
| optical base material | 0 |
| of the comparative | |
| example 2 | |

### Measurement of Zeta Potential

With respect to the optical base material having low autofluorescence and good adhesive property to cell, which is used for the fluorescence observation and/or a fluorescence photometry system in embodiments 1 and 2, and the optical base material used for the fluorescence observation and/or fluorescence photometry system in a comparative example 2, zeta potential in pH 7 was measured using electrophoresis light scattering photometer ELS-800 (made by Otsuka Denshi Co.). A measurement result is shown in the table 2. As the result of the measurement, in the optical base material of the comparative example 2, zeta potential was shown as a big value such as −104 mV. Contrary to this, On the other hand, in the optical base material having low autofluorescence and good adhesive property to cell in the embodiments 1 and 2, it is shown that Zeta potential was −35 mV and 10 mV. Thus, zeta potential has been improved toward positive direction relatively in comparison with the optical base material of the comparative example 1,

TABLE 2

| sample | zeta potential/mV |
|---|---|
| optical base material | −35 |
| of the embodiment 1 | |
| optical base material | 10 |
| of the embodiment 2 | |
| optical base material | −104 |
| of the comparative | |
| example 2 | |

As mentioned above, the fluorescence observation or the fluorescence photometry system, and fluorescence observation or fluorescence photometry method using an optical base material having low autofluorescence and good adhesive property to cell of the present invention has features as shown in the followings besides inventions shown in the claims.

(1) The fluorescence observation or fluorescence photometry system using an optical base material having low autofluorescence and good adhesive property to cell according to one of claims 1˜7, wherein said optical base material having low autofluorescence and good adhesive property to cell satisfies the following condition (1-2).

B_{CG′}/B_{CG}≦0.5 (1-2)

where B_{CG′} is an average of the intensity of the autofluorescence of said optical base material having low autofluorescence and good adhesive property to cell, and B_{CG} is an average of the intensity of the autofluorescence of a cover glass generally used conventionally.

(2) The fluorescence observation or fluorescence photometry system using an optical base material having low autofluorescence and good adhesive property to cell according to one of claims 1˜7, wherein said optical base material having low autofluorescence and good adhesive property to cell satisfies the following condition (1-3):

B_{CG′}/B_{CG}≦0.3 (1-3)

Where B_{CG′} is an average of the intensity of the autofluorescence of said optical base material having low autofluorescence and good adhesive property to cell, and B_{CG} is an average of the intensity of the autofluorescence of a cover glass generally used conventionally.

(3) The fluorescence observation or fluorescence photometry method using an optical base material having low autofluorescence and good adhesive property to cell according to claim 9, wherein the sample which emits fluorescence by using a living cell selected by said process (A) satisfies at least one of the following conditions (2-2) and (3-2):

(S−s)/(B+b)≦3 (2-2)

3B_{CG}/B≧0.4 (3-2)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

(4) The fluorescence observation or fluorescence photometry method using an optical base material having low autofluorescence and good adhesive property to cell, which is mentioned in (3), wherein an application selected by said process (B) is FRET (Fluorescence Resonance Energy Transfer).

(5) The fluorescence observation or fluorescence photometry method using an optical base material having low autofluorescence and good adhesive property to cell, which is mentioned in (4), wherein the system selected by said process (B) is a fluorescence microscope system.

(6) The fluorescence observation or fluorescence photometry method using an optical base material having low autofluorescence and good adhesive property to cell, which is mentioned in (4), wherein the system selected by said process (B) is a total reflection microscope system.

(7) The fluorescence observation or fluorescence photometry method using an optical base material having low autofluorescence and good adhesive property to cell, which is mentioned in (4), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(8) The fluorescence observation or fluorescence photometry method using an optical base material having low autofluorescence and good adhesive property to cell, which is mentioned in (3) wherein the application selected by said process (B) is a calcium ion imaging.

(9) The fluorescence observation or fluorescence photometry method using an optical base material having low autofluorescence and good adhesive property to cell, which is mentioned in (8), wherein the system selected by said process (B) is a fluorescence microscope system.

(10) The fluorescence observation or fluorescence photometry method using an optical base material having low autofluorescence and good adhesive property to cell, which is mentioned in (8), wherein the system selected by said process (B) is a total reflection microscope system.

(11) The fluorescence observation or fluorescence photometry method using an optical base material having low autofluorescence and good adhesive property to cell, which is mentioned in (8), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(12) The fluorescence observation or fluorescence photometry method using an optical base material having low autofluorescence and good adhesive property to cell, which is mentioned in (3), wherein the application selected by said process (B) is an animation observation or time lapse observation.

(13) The fluorescence observation or fluorescence photometry method using an optical base material having low autofluorescence and good adhesive property to cell, which is mentioned in (12), wherein the system selected by said process (B) is a fluorescence microscope system.

(14) The fluorescence observation or fluorescence photometry method using an optical base material having low autofluorescence and good adhesive property to cell, which is mentioned in (12), wherein the system selected by said process (B) is a total reflection microscope system.

(15) The fluorescence observation or fluorescence photometry method using an optical base material having low autofluorescence and good adhesive property to cell, which is mentioned in (12), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(16) The fluorescence observation or fluorescence photometry method using an optical base material having low autofluorescence and good adhesive property to cell according to claim 9, wherein the sample which emits fluorescence by using a living cell selected by said process (A) satisfies at least one of the following conditions (2-1) and (3-1):

(S−s)/(B+b)≦2 (2-3)

3B_{CG}/B≧0.6 (3-3)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally

(17) The fluorescence observation or fluorescence photometry method using an optical base material having low autofluorescence and good adhesive property to cell, which is mentioned in (16), wherein an application selected by said process (B) is FRET (Fluorescence Resonance Energy Transfer).

(18) The fluorescence observation or fluorescence photometry method using an optical base material having low autofluorescence and good adhesive property to cell, which is mentioned in (17), wherein the system selected by said process (B) is a fluorescence microscope system.

(19) The fluorescence observation or fluorescence photometry method using an optical base material having low autofluorescence and good adhesive property to cell, which is mentioned in (17), wherein the system selected by said process (B) is a total reflection microscope system.

(20) The fluorescence observation or fluorescence photometry method using an optical base material having low autofluorescence and good adhesive property to cell, which is mentioned in (17), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(21) The fluorescence observation or fluorescence photometry method using an optical base material having low autofluorescence and good adhesive property to cell, which is mentioned in (16), wherein the application selected by said process (B) is a calcium ion imaging.

(22) The fluorescence observation or fluorescence photometry method using an optical base material having low autofluorescence and good adhesive property to cell, which is mentioned in (21), wherein the system selected by said process (B) is a fluorescence microscope system.

(23) The fluorescence observation or fluorescence photometry method using an optical base material having low autofluorescence and good adhesive property to cell, which is mentioned in (21), wherein the system selected by said process (B) is a total reflection microscope system.

(24) The fluorescence observation or fluorescence photometry method using an optical base material having low autofluorescence and good adhesive property to cell, which is mentioned in (21), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(25) The fluorescence observation or fluorescence photometry method using an optical base material having low autofluorescence and good adhesive property to cell, which is mentioned in (16), wherein the application selected by said process (B) is an animation observation or a time lapse observation.

(26) The fluorescence observation or fluorescence photometry method using an optical base material having low autofluorescence and good adhesive property to cell which is mentioned in (25), wherein the system selected by said process (B) is a fluorescence microscope system.

(27) The fluorescence observation or fluorescence photometry method using an optical base material having low autofluorescence and good adhesive property to cell, which is mentioned in (25), wherein the system selected by said process (B) is a total reflection microscope system.

(28) The fluorescence observation or fluorescence photometry method using an optical base material having low autofluorescence and good adhesive property to cell, which is mentioned in (25), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(29) A fluorescence observation or fluorescence photometry method using an optical base material having low autofluorescence and good adhesive property to cell, wherein in a fluorescence observation or a fluorescence photometry method, it consists of the following processes A), (B), and (C);

(A) a process for selecting the sample which emits the fluorescence using a living cell;

(B) a process for selecting an application for observing or measuring the intensity of the light of the sample selected by said process (A), and a fluorescence observation or fluorescence photometry system using an optical base material having low autofluorescence and good adhesive property to cell according to Claims 1˜7, wherein the following condition (1-2) is satisfied;

C) a process for carrying out the fluorescence observation or the fluorescence photometry of the sample selected by said process (A), by using the application and the system which were selected by said process:

B_{CG′}/B_{CG}≦0.5 (1-2)

where B_{CG′} is an average of the intensity of the autofluorescence of said optical base material having low autofluorescence and good adhesive property to cell and B_{CG} is an average of the intensity of the autofluorescence of a cover glass generally used conventionally.

(30) The fluorescence observation or fluorescence photometry method using an optical base material having low autofluorescence and good adhesive property to cell, which is mentioned in (25), wherein the sample which emits fluorescence by using a living cell selected by said process (A) satisfies at least one of the following conditions (2-1) and (3-1):

(S−s)/(B+b)≦5 (2-1)

3B_{CG}/B≧0.2 (3-1)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

(31) The fluorescence observation or fluorescence photometry method using an optical base material having low autofluorescence and good adhesive property to cell, which is mentioned in (30), wherein an application selected by said process (B) is FRET (Fluorescence Resonance Energy Transfer).

(32). The fluorescence observation or fluorescence photometry method using an optical base material having low autofluorescence and good adhesive property to cell which is mentioned in (31), wherein the system selected by said process (B) is a fluorescence microscope system.

(33) The fluorescence observation or fluorescence photometry method using an optical base material having low autofluorescence and good adhesive property to cell, which is mentioned in (31), wherein the system selected by said process (B) is a total reflection microscope system.

(34) The fluorescence observation or fluorescence photometry method using an optical base material having low autofluorescence and good adhesive property to cell, which is mentioned in (31), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(35) The fluorescence observation or fluorescence photometry method using an optical base material having low autofluorescence and good adhesive property to cell which is mentioned in (30), wherein the application selected by said process (B) is a calcium ion imaging.

(36) The fluorescence observation or fluorescence photometry method using an optical base material having low autofluorescence and good adhesive property to cell which is mentioned in (35), wherein the system selected by said process (B) is a fluorescence microscope system.

(37). The fluorescence observation or fluorescence photometry method using an optical base material having low autofluorescence and good adhesive property to cell which is mentioned in (35), wherein the system selected by said process (B) is a total reflection microscope system.

(38). The fluorescence observation or fluorescence photometry method using an optical base material having low autofluorescence and good adhesive property to cell, which is mentioned in (35), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(39). The fluorescence observation or fluorescence photometry method using an optical base material having low autofluorescence and good adhesive property to cell, which is mentioned in (30), wherein the application selected by said process (B) is an animation observation or a time lapse observation.

(40). The fluorescence observation or fluorescence photometry method using an optical base material having low autofluorescence and good adhesive property to cell, which is mentioned in (39), wherein the system selected by said process (B) is a fluorescence microscope system.

(41). The fluorescence observation or fluorescence photometry method using an optical base material having low autofluorescence and good adhesive property to cell, which is mentioned in (39), wherein the system selected by said process (B) is a total reflection microscope system.

(42). The fluorescence observation or fluorescence photometry method using an optical base material having low autofluorescence and good adhesive property to cell, which is mentioned in (39), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(43) The fluorescence observation or fluorescence photometry method using an optical base material having low autofluorescence and good adhesive property to cell, which is mentioned in (29), wherein the sample which emits fluorescence by using a living cell selected by said process (A) satisfies at least one of the following conditions (2-2) and (3-2):

(S−s)/(B+b)≦3 (2-2)

3B_{CG}/B≧0.4 (3-2)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

(44) The fluorescence observation or fluorescence photometry method using an optical base material having low autofluorescence and good adhesive property to cell, which is mentioned in (43), wherein an application selected by said process (B) is FRET (Fluorescence Resonance Energy Transfer).

(45) The fluorescence observation or fluorescence photometry method using an optical base material having low autofluorescence and good adhesive property to cell, which is mentioned in (44), wherein the system selected by said process (B) is a fluorescence microscope system.

(46) The fluorescence observation or fluorescence photometry method using an optical base material having low autofluorescence and good adhesive property to cell, which is mentioned in (44), wherein the system selected by said process (B) is a total reflection microscope system.

(47) The fluorescence observation or fluorescence photometry method using an optical base material having low autofluorescence and good adhesive property to cell, which is mentioned in (44), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(48) The fluorescence observation or fluorescence photometry method using an optical base material having low autofluorescence and good adhesive property to cell, which is mentioned in (43), wherein the application selected by said process (B) is a calcium ion imaging.

(49) The fluorescence observation or fluorescence photometry method using an optical base material having low autofluorescence and good adhesive property to cell, which is mentioned in (48), wherein the system selected by said process (B) is a fluorescence microscope system.

(50) The fluorescence observation or fluorescence photometry method using an optical base material having low autofluorescence and good adhesive property to cell, which is mentioned in (48), wherein the system selected by said process (B) is a total reflection microscope system.

(51) The fluorescence observation or fluorescence photometry method using an optical base material having low autofluorescence and good adhesive property to cell, which is mentioned in (48), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(52) The fluorescence observation or fluorescence photometry method using an optical base material having low autofluorescence and good adhesive property to cell, which is mentioned in (48), wherein the application selected by said process (B) is an animation observation or a time lapse observation.

(53) The fluorescence observation or fluorescence photometry method using an optical base material having low autofluorescence and good adhesive property to cell, which is mentioned in (52), wherein the system selected by said process (B) is a fluorescence microscope system.

(54) The fluorescence observation or fluorescence photometry method using an optical base material having low autofluorescence and good adhesive property to cell, which is mentioned in (52), wherein the system selected by said process (B) is a total reflection microscope system.

(55) The fluorescence observation or fluorescence photometry method using an optical base material having low autofluorescence and good adhesive property to cell, which is mentioned in (52), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(56) The fluorescence observation or fluorescence photometry method using an optical base material having low autofluorescence and good adhesive property to cell, which is mentioned in (29), wherein the sample which emits fluorescence by using a living cell selected by said process (A) satisfies at least one of the following conditions (2-1) and (3-1):

(S−s)/(B+b)≦2 (2-3)

3B_{CG}/B≧0.6 (3-3)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

(57) The fluorescence observation or fluorescence photometry method using an optical base material having low autofluorescence and good adhesive property to cell, which is mentioned in (56), wherein an application selected by said process (B) is FRET (Fluorescence Resonance Energy Transfer).

(58) The fluorescence observation or fluorescence photometry method using an optical base material having low autofluorescence and good adhesive property to cell, which is mentioned in (57), wherein the system selected by said process (B) is a fluorescence microscope system.

(59) The fluorescence observation or fluorescence photometry method using an optical base material having low autofluorescence and good adhesive property to cell, which is mentioned in (57), wherein the system selected by said process (B) is a total reflection microscope system.

(60) The fluorescence observation or fluorescence photometry method using an optical base material having low autofluorescence and good adhesive property to cell, which is mentioned in (57), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(61) The fluorescence observation or fluorescence photometry method using an optical base material having low autofiluorescence and good adhesive property to cell, which is mentioned in (56), wherein the application selected by said process (B) is a calcium ion imaging.

(62) The fluorescence observation or fluorescence photometry method using an optical base material having low autofluorescence and good adhesive property to cell, which is mentioned in (61), wherein the system selected by said process (B) is a fluorescence microscope system.

(63) The fluorescence observation or fluorescence photometry method using an optical base material having low autofluorescence and good adhesive property to cell, which is mentioned in (61), wherein the system selected by said process (B) is a total reflection microscope system.

(64) The fluorescence observation or fluorescence photometry method using an optical base material having low autofluorescence and good adhesive property to cell, which is mentioned in (61), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other. (65) The fluorescence observation or fluorescence photometry method using an optical base material having low autofluorescence and good adhesive property to cell, which is mentioned in (56), wherein the application selected by said process (B) is an animation observation or a time lapse observation.

(66) The fluorescence observation or fluorescence photometry method using an optical base material having low autofluorescence and good adhesive property to cell, which is mentioned in (65), wherein the system selected by said process (B) is a fluorescence microscope system.

(67) The fluorescence observation or fluorescence photometry method using an optical base material having low autofluorescence and good adhesive property to cell, which is mentioned in (65), wherein the system selected by said process (B) is a total reflection microscope system.

(68) The fluorescence observation or fluorescence photometry method using an optical base material having low autofluorescence and good adhesive property to cell, which is mentioned in (65), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(69) A fluorescence observation or fluorescence photometry method using an optical base material having low autofluorescence and good adhesive property to cell, wherein in a fluorescence observation or a fluorescence photometry method, it consists of the following processes (A), (B), and (C):

(A) a process for selecting the sample which emits the fluorescence using a living cell;

(B) a process for selecting an application for observing or measuring the intensity of the light of the sample selected by said process (A), and a fluorescence observation or fluorescence photometry system using an optical base material having low autofluorescence and good adhesive property to cell according to Claims 1˜7, wherein the following condition (1-3) is satisfied; and

C) a process for carrying out the fluorescence observation or the fluorescence photometry of the sample selected by said process (A), by using the application and the system which were selected by said process:

B_{CG′}/B_{CG}≦0.3 (1-3)

where B_{CG′} is an average of the intensity of the autofluorescence of said optical base material having low autofluorescence and good adhesive property to cell, and B_{CG} is an average of the intensity of the autofluorescence of a cover glass generally used conventionally.

(70) The fluorescence observation or fluorescence photometry method using an optical base material having low autofluorescence and good adhesive property to cell, which is mentioned in (69), wherein the sample which emits fluorescence by using a living cell selected by said process (A) satisfies at least one of the following conditions (2-1) and (3-1):

(S−s)/(B+b)≦5 (2-1)

3B_{CG}/B≧0.2 (3-1)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

(71) The fluorescence observation or fluorescence photometry method using an optical base material having low autofluorescence and good adhesive property to cell, which is mentioned in (70), wherein an application selected by said process (B) is FRET (Fluorescence Resonance Energy Transfer).

(72) The fluorescence observation or fluorescence photometry method using an optical base material having low autofluorescence and good adhesive property to cell which is mentioned in (71), wherein the system selected by said process (B) is a fluorescence microscope system.

(73) The fluorescence observation or fluorescence photometry method using an optical base material having low autofluorescence and good adhesive property to cell, which is mentioned in (71), wherein the system selected by said process (B) is a total reflection microscope system.

(74) The fluorescence observation or fluorescence photometry method using an optical base material having low autofluorescence and good adhesive property to cell, which is mentioned in (71), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(75) The fluorescence observation or fluorescence photometry method using an optical base material having low autofluorescence and good adhesive property to cell which is mentioned in (70), wherein the application selected by said process (B) is a calcium ion imaging.

(76) The fluorescence observation or fluorescence photometry method using an optical base material having low autofluorescence and good adhesive property to cell which is mentioned in (75), wherein the system selected by said process (B) is a fluorescence microscope system.

(77) The fluorescence observation or fluorescence photometry method using an optical base material having low autofluorescence and good adhesive property to cell, which is mentioned in (75), wherein the system selected by said process (B) is a total reflection microscope system.

(78) The fluorescence observation or fluorescence photometry method using an optical base material having low autofluorescence and good adhesive property to cell, which is mentioned in (75), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(79) The fluorescence observation or fluorescence photometry method using an optical base material having low autofluorescence and good adhesive property to cell, which is mentioned in (70), wherein the application selected by said process (B) is an animation observation or a time lapse observation.

(80) The fluorescence observation or fluorescence photometry method using an optical base material having low autofluorescence and good adhesive property to cell, which is mentioned in (79), wherein the system selected by said process (B) is a fluorescence microscope system.

(81) The fluorescence observation or fluorescence photometry method using an optical base material having low autofluorescence and good adhesive property to cell, which is mentioned in (79), wherein the system selected by said process (B) is a total reflection microscope system.

(82) The fluorescence observation or fluorescence photometry method using an optical base material having low autofluorescence and good adhesive property to cell, which is mentioned in (79), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(83) The fluorescence observation or fluorescence photometry method using an optical base material having low autofluorescence and good adhesive property to cell, which is mentioned in (69), wherein the sample which emits fluorescence by using a living cell selected by said process (A) satisfies at least one of the following conditions (2-2) and (3-2):

(S−s)/(B+b)≦3 (2-2)

3B_{CG}/B≧0.4 (3-2)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

(84) The fluorescence observation or fluorescence photometry method using an optical base material having low autofluorescence and good adhesive property to cell, which is mentioned in (83), wherein an application selected by said process (B) is FRET (Fluorescence Resonance Energy Transfer).

(85) The fluorescence observation or fluorescence photometry method using an optical base material having low autofluorescence and good adhesive property to cell, which is mentioned in (84), wherein the system selected by said process (B) is a fluorescence microscope system.

(86) The fluorescence observation or fluorescence photometry method using an optical base material having low autofluorescence and good adhesive property to cell, which is mentioned in (84), wherein the system selected by said process (B) is a total reflection microscope system.

(87) The fluorescence observation or fluorescence photometry method using an optical base material having low autofluorescence and good adhesive property to cells which is mentioned in (84), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(88) The fluorescence observation or fluorescence photometry method using an optical base material having low autofluorescence and good adhesive property to cell, which is mentioned in (83), wherein the application selected by said process (B) is a calcium ion imaging.

(89) The fluorescence observation or fluorescence photometry method using an optical base material having low autofluorescence and good adhesive property to cell, which is mentioned in (88), wherein the system selected by said process (B) is a fluorescence microscope system.

(90) The fluorescence observation or fluorescence photometry method using an optical base material having low autofluorescence and good adhesive property to cell, which is mentioned in (88), wherein the system selected by said process (B) is a total reflection microscope system.

(91) The fluorescence observation or fluorescence photometry method using an optical base material having low autofluorescence and good adhesive property to cell, which is mentioned in (88), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(92) The fluorescence observation or fluorescence photometry method using an optical base material having low autofluorescence and good adhesive property to cell, which is mentioned in (83), wherein the application selected by said process (B) is an animation observation or a time lapse observation.

(93) The fluorescence observation or fluorescence photometry method using an optical base material having low autofluorescence and good adhesive property to cell, which is mentioned in (92), wherein the system selected by said process (B) is a fluorescence microscope system.

(94) The fluorescence observation or fluorescence photometry method using an optical base material having low autofluorescence and good adhesive property to cell, which is mentioned in (92), wherein the system selected by said process (B) is a total reflection microscope system.

(95) The fluorescence observation or fluorescence photometry method using an optical base material having low autofluorescence and good adhesive property to cell, which is mentioned in (92), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(96) The fluorescence observation or fluorescence photometry method using an optical base material having low autofluorescence and good adhesive property to cell, which is mentioned in (69), wherein the sample which emits fluorescence by using a living cell selected by said process (A) satisfies at least one of the following conditions (2-1) and (3-1):

(S−s)/(B+b)≦0.2 (2-3)

3B_{CG}/B≧0.6 (3-3)

where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

(97) The fluorescence observation or fluorescence photometry method using an optical base material having low autofluorescence and good adhesive property to cell, which is mentioned in (96), wherein an application selected by said process (B) is FRET (Fluorescence Resonance Energy Transfer).

(98) The fluorescence observation or fluorescence photometry method using an optical base material having low autofluorescence and good adhesive property to cell, which is mentioned in (97), wherein the system selected by said process (B) is a fluorescence microscope system.

(99) The fluorescence observation or fluorescence photometry method using an optical base material having low autofluorescence and good adhesive property to cell, which is mentioned in (97), wherein the system selected by said process (B) is a total reflection microscope system.

(100) The fluorescence observation or fluorescence photometry method using an optical base material having low autofluorescence and good adhesive property to cell, which is mentioned in (97), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(101) The fluorescence observation or fluorescence photometry method using an optical base material having low autofluorescence and good adhesive property to cell, which is mentioned in (96), wherein the application selected by said process (B) is a calcium ion imaging.

(102) The fluorescence observation or fluorescence photometry method using an optical base material having low autofluorescence and good adhesive property to cell, which is mentioned in (101), wherein the system selected by said process (B) is a fluorescence microscope system.

(103) The fluorescence observation or fluorescence photometry method using an optical base material having low autofluorescence and good adhesive property to cell, which is mentioned in (101), wherein the system selected by said process (B) is a total reflection microscope system.

(104) The fluorescence observation or fluorescence photometry method using an optical base material having low autofluorescence and good adhesive property to cell, which is mentioned in (101), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

(105) The fluorescence observation or fluorescence photometry method using an optical base material having low autofluorescence and good adhesive property to cell, which is mentioned in (96), wherein the application selected by said process (B) is an animation observation or a time lapse observation.

(106) The fluorescence observation or fluorescence photometry method using an optical base material having low autofluorescence and good adhesive property to cell, which is mentioned in (105), wherein the system selected by said process (B) is a fluorescence microscope system.

(107) The fluorescence observation or fluorescence photometry method using an optical base material having low autofluorescence and good adhesive property to cell, which is mentioned in (105), wherein the system selected by said process (B) is a total reflection microscope system.

(108) The fluorescence observation or fluorescence photometry method using an optical base material having low autofluorescence and good adhesive property to cell, which is mentioned in (105), wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other

The fluorescence observation and/or fluorescence photometry system using an optical base material having low autofluorescence and good adhesive property to cell according to the present invention is useful in such fields that are fields of microscope, fluorescence microscope, equipment for analyzing of protein, and/or the DNA, where accurate measurement of quantity including noise is required, namely, fields where importance about the technology for observing or measuring weak fluorescence correctly by using a wide wavelength band is increasing, and accurate measurement of quantity including noise is required.

What is claimed is:

1. A fluorescence observation or fluorescence photometry system using an optical base material having low autofluorescence and good adhesive property to cell, wherein an optical instrument constituted for enabling a fluorescence observation and/or a fluorescence measurement is arranged, and said optical base material has the following optical characteristics:
3≦nd≦1.9
15≦νd≦100
where nd represents refractive index in d line, and νd represents Abbe number in d line.

2. A fluorescence observation or fluorescence photometry system using an optical base material having low autofluorescence and good adhesive property to cell, wherein an optical instrument constituted for enabling a fluorescence observation and/or a fluorescence measurement is arranged, and said optical base material has the following optical characteristics:
1.6nd≦1.9
35≦νd≦65
where nd represents refractive index in d line, and νd represents Abbe number in d line.

3. A fluorescence observation or fluorescence photometry system using an optical base material having low autofluorescence and good adhesive property to cell, wherein an optical instrument constituted for enabling a fluorescence observation and/or a fluorescence measurement is arranged, and said optical base material has the following optical characteristics:
1.7≦nd≦1.8
40≦νd≦60
where nd represents refractive index in d line, and νd represents Abbe number in d line.

4. A fluorescence observation or fluorescence photometry system using an optical base material having low autofluorescence and good adhesive property to cell, wherein an optical instrument constituted for enabling a fluorescence observation and/or a fluorescence measurement is arranged, and said optical base material has the following optical characteristics:
1.35≦nd≦1.5
30≦νd≦100
where nd represents refractive index in d line; νd represents Abbe number in d line.

5. A fluorescence observation or fluorescence photometry system using an optical base material having low autofluorescence and good adhesive property to cell, wherein an optical instrument constituted for enabling a fluorescence observation and/or a fluorescence measurement is arranged, and said optical base material has the following optical characteristics:
1.37≦nd≦1.48
35≦νd≦75
where nd represents refractive index in d line, and νd represents Abbe number in d line.

6 The fluorescence observation or fluorescence photometry system using an optical base material having low autofluorescence and good adhesive property to cell according to claim 1, wherein said optical base material is coated by silane coupling reagent containing amino group having positive surface charge.

7. The fluorescence observation or fluorescence photometry system using an optical base material having low autofluorescence and good adhesive property to cell according to claim 6, wherein a glass base material of said optical base material is coated by said silane coupling reagent.

8. The fluorescence observation or fluorescence photometry system using an optical base material having low autofluorescence and good adhesive property to cell according to claim 1, wherein said optical base material satisfies the following condition (1-1):
B_{CG′}/B_{CG}≦0.7 (1-1)
where B_{CG′} is an average of the intensity of the autofluorescence of said optical base material, and B_{CG} is an average of the intensity of the autofluorescence of a cover glass generally used conventionally.

9. A fluorescence observation or fluorescence photometry method using an optical base material having low autofluorescence and good adhesive property to cell, wherein in a fluorescence observation or a fluorescence photometry method, it consists of the following processes (A), (B), and (C):
(A) a process for selecting the sample which emits the fluorescence using a living cell;
(B) a process for selecting an application for observing or measuring the intensity of the light of the sample selected by said process (A), and a fluorescence observation or fluorescence photometry system using an optical base material having low autofluorescence and good adhesive property to cell according to claim 1, wherein the following condition (1-1) is satisfied; and
(C) a process for carrying out the fluorescence observation or the fluorescence photometry of the sample selected by said process (A), by using the application and the system which were selected by said process.
B_{CG′}/B_{CG}≦0.7 (1-1)
where B_{CG′} is an average of the intensity of the autofluorescence of said optical base material, and B_{CG} is an average of the intensity of the autofluorescence of a cover glass generally used conventionally.

10. The fluorescence observation or fluorescence photometry method using an optical base material having low autofluorescence and good adhesive property to cell according to claim 9, wherein the sample which emits fluorescence by using a living cell selected by said process (A) satisfies at least one of the following conditions (2-1) and (3-1):
(S−s)/(B+b)≦5 (2-1)
3B_{CG}/B≧0.2 (3-1)
where S is an average of the intensity of the fluorescence which said sample emits, s is a fluctuation width of the intensity of the fluorescence, B is an average of the intensity of a background noise when the sample is not set, b is a fluctuation width of the intensity of the background noise, and B_{CG} is an average of the intensity of the autofluorescence of a cover glass generally used conventionally.

11. The fluorescence observation or fluorescence photometry method using an optical base material having low autofluorescence and good adhesive property to cell according to claim 10, wherein an application selected by said process (B) is FRET (Fluorescence Resonance Energy Transfer).

12. The fluorescence observation or fluorescence photometry method using an optical base material having low autofluorescence and good adhesive property to cell according to claim 11, wherein the system selected by said process (B) is a fluorescence microscope system.

13. The fluorescence observation or fluorescence photometry method using an optical base material having low autofluorescence and good adhesive property to cell according to claim 11, wherein the system selected by said process (B) is a total reflection microscope system.

14. The fluorescence observation or fluorescence photometry method using an optical base material having low autofluorescence and good adhesive property to cell according to claim 11, wherein the system selected by said process (B) has two fluorescence microscopes or two total reflection microscopes; otherwise, one fluorescence microscope and one total reflection microscope; and the system is constituted as a microscope system in which said sample is sandwiched by the objective optical systems being faced each other.

15. The fluorescence observation or fluorescence photometry method using an optical base material having low autofluorescence and good adhesive property to cell according to claim 10, wherein the application selected by said process (B) is a calcium ion imaging.

16. The fluorescence observation or fluorescence photometry method using an optical base material having low autofluorescence and good adhesive property to cell according to claim 15, wherein the system selected by said process (B) is a fluorescence microscope system.

17. The fluorescence observation or fluorescence photometry method using an optical base material having low autofluorescence and good adhesive property to cell according to claim 11, wherein the system selected by said process (B) is a total reflection microscope system.

18. The fluorescence observation or fluorescence photometry method using an optical base material having low autofluorescence and good adhesive property to cell according to claim 15, wherein the system selected by said process (B) has two fluorescence microscopes or two total reflection microscopes; otherwise one fluorescence microscope and one total reflection microscope; and the system is constituted as a microscope system in which said sample is sandwiched between the objective optical systems being faced each other.

19. The fluorescence observation or fluorescence photometry method using an optical base material having low autofluorescence and good adhesive property to cell according to claim 10, wherein the application selected by said process (B) is an animation observation or a time lapse observation.

20. The fluorescence observation or fluorescence photometry method using an optical base material having low autofluorescence and good adhesive property to cell according to claim 19, wherein the system selected by said process (B) is a fluorescence microscope system.

21. The fluorescence observation or fluorescence photometry method using an optical base material having low autofluorescence and good adhesive property to cell according to claim 19, wherein the system selected by said process (B) is a total reflection microscope system.

22. The fluorescence observation or fluorescence photometry method using an optical base material having low autofluorescence and good adhesive property to cell according to claim 19, wherein the system selected by said process (B) has two fluorescence microscopes or two total reflection microscopes; otherwise, one fluorescence microscope and one total reflection microscope, and the system is constituted as a microscope system in which said sample is sandwiched by the objective optical systems being faced each other.
